(19) United States
(12) Patent Application Publication
(10) Pub. No.: US 2006/0262250 A1
(43) Pub. Date: Nov. 23, 2006

(54) Microstructured optical device for polarization and wavelength filtering

(76) Inventor: Douglas S. Hobbs, Lexington, MA (US)

Correspondence Address: MIRICK, O'CONNELL, DEMALLIE & LOUGEE, 100 FRONT STREET, WORCESTER, MA, 01608, US

(21) Appl. No.: 11/436,707

(22) Filed: May 18, 2006

Related U.S. Application Data
(60) Provisional application No. 60/682,049, filed on May 18, 2005.

(51) Int. Cl. G02F 1/1335

(52) U.S. Cl. 349/96

(57) ABSTRACT

A microstructure-based polarizer is described. The device acts as an electromagnetic wave filter in the optical region of the spectrum, filtering multiple wavelength bands and polarization states. The apparatus comprises a substrate having a surface relief structure containing dielectric bodies with physical dimensions smaller than the wavelength of the filtered electromagnetic waves, such structures repeated in an array covering at least a portion of the surface of the substrate. The disclosed structure is particularly useful as a reflective polarizer in a liquid crystal display, or as polarizing color filter elements at each pixel in a display. Other applications such as polarization encoded security labels, polarized room lighting, and color filter arrays for electronic imaging systems are made practical by the device.

### CROSS REFERENCE TO RELATED APPLICATION

This application claims priority of Provisional Application Ser. No. 60/682,049, filed on May 18, 2005 entitled “MICROSTRUCTURED OPTICAL DEVICE FOR POLARIZATION AND WAVELENGTH FILTERING”.

### FIELD OF THE INVENTION

This invention relates to an optical device that filters wavelengths of light, and filters the light polarization. Wavelength and polarization filters are common optical elements in displays, room lighting, video and still imaging cameras, and security labels and tags. The invention will find particular use as a polarizing element for laser and LED light sources used in communication and security systems, and most significantly, as inexpensive, high-efficiency polarizing filters for liquid crystal display backlights or color filter arrays.

### BACKGROUND OF THE INVENTION

Thin, flat, information and video displays based on liquid crystal technology are used exclusively in portable computers and hand-held devices such as mobile phones and personal data assistants (PDAs). Liquid crystal displays, or LCDs, are rapidly replacing cathode ray tube (CRT) displays in desktop computer and home video markets.

A typical LCD used in a laptop computer or television consists of two main modules; the liquid crystal panel, and a light source and distribution system known as the backlight. The liquid crystal panel is divided into millions of individual picture elements, or pixels, that upon application of an electronic signal, serve as shutters to block or pass light sourced from the backlight. Dyes that absorb all but a narrow range of color, typically red, green, and blue, are integrated between the white light source and each pixel to generate full color displays.

To produce the shuttering effect, liquid crystal material that can be thought of as a solution of organic, long-chain, cylinder-shaped molecules, is sandwiched between sheets of polarization filtering film—or polarizers. Each polarizer has a unique axis that only passes light with an electric field vibrating parallel to the axis—absorbing all other light. By orienting the two polarizers with their axes crossed—rotated ninety degrees—no light is transmitted. When the long-chain liquid crystal molecules are aligned between the crossed polarizers, the polarization of the light passed by the first polarizer can be rotated to align with the transmission axis of the second polarizer—allowing light to be transmitted. Rotation of the liquid crystal molecules is affected by applying an electric field between the sheet polarizers along which the liquid crystal molecules will align. When the field is applied the shutter is closed and light is blocked.

The amount of light transmitted through the liquid crystal pixels is limited by the absorption in both the color filtering dyes and the polarizing sheets. The transmission of white light through an aligned pair of standard Polaroid films is less than 20 percent, while the transmission of a single color filter is at best 70 percent. Combined the transmission of a single color pixel is less than 12 percent of the available light from the backlight. This poor light transmission limited the market acceptance of LCDs for many years.

There is an immediate need for higher transmission polarization and color filtering films to increase the brightness of LCDs. In recent years, the 3M Company has introduced a reflective polarizing film with high transmission that is used to replace the first polarizer in an LCD (See U.S. Pat. No. 6,543,153 issued Apr. 8, 2003). This single 3M film, combined with other brightness enhancing films (BEF), doubles the light transmitted by the LCD, allowing the display to be visible in a wider range of environments. In addition, the 3M film recycles the light that is not passed by reflection back into the light distribution films that comprise the backlight.

The reflective polarizing film produced by 3M is highly complex and expensive. The 3M polarizer consists of a stack of over six hundred layers of thin films coated on a plastic sheet. Once coated, the film stack is stretched in one or more directions to produce the anisotropy needed to create the polarizing effect.

Surface relief microstructures can be configured to produce phase retarding devices that operate on polarized light. Both half- and quarter-waveplates have been demonstrated using surface relief gratings. Such structures can be mass produced inexpensively using modern replication techniques. Polarizing elements can be made from surface relief gratings when a thin metal layer is deposited selectively only on the tops of (or in the valleys between) the grating lines. Such devices are known as wire-grid polarizers. Wire-grid polarizers are commonly used for polarizing infrared light, but have not been accepted for use with visible light because of the absorption loss from the metal lines and the requirement of producing extremely small grating line widths—typically on the order of 60 to 75 nanometer (nm)—patterned over areas which can be large such as in the display application. Wire-grid polarizers may find use with micro-displays used in projections systems.

There are two types of surface relief microstructures known in the art that can function as optical wavelength filters. The first type is referred to as an “Aztec” structure in the literature and was disclosed and fully described by Cowan in U.S. Pat. Nos. 4,839,250, 4,874,213, and 4,888,260. Aztec surface structures resemble stepped pyramids where each step height corresponds to one half the wavelength of light that will add coherently upon reflection. An Aztec structure will reflect a narrow range of wavelengths out of a broad wavelength light source. Aztec structures in general exhibit very little effect on the light polarization, and in fact are often designed specifically to be polarization insensitive as discussed is U.S. Pat. Nos. 6,707,518, and 6,791,757.

A second technique for generating an optical filter function from a surface relief microstructure is to exploit a surface structure waveguide effect. Here an Aztec structure or a simple array of structures such as holes or posts, can be embedded in a region of high refractive index to create a waveguide resonator. Such three or two dimensional structural filters have received great attention in the recent literature in the context of optical telecommunications and optical computing, where they are known as “photonic bandgap” devices. Using two and three-dimensional guided-mode waveguide resonators as filters is less well-known in the art but has been described in the literature. (See Magnusson U.S. Pat. Nos. 5,216,680, 5,598,300, and 6,154,480. Also, S. Peng and G. M. Morris, “Resonant Scattering from two-dimensional gratings”, J. Opt. Soc. Am. A, Vol. 13, No. 5, p. 993, May 1996; R. Magnusson and S. S. Wang, “New Principle for optical filters,” Appl. Phys. Lett., 61, No. 9, p. 1022, August 1992.)

To generate the resonance effect, a guided-mode surface structure filter is composed of features with dimensions (height, width, and spacing) smaller than the wavelengths of light used in the illuminating light. Because the structures are composed of a material with a higher density than the surrounding medium, a waveguide is created in a direction orthogonal to the propagation direction. A range of wavelengths in the illuminating light will be confined and radially propagate a short distance in the plane of the structures, where it will undergo reflection. Waves traveling radially outward in the plane will interfere with waves reflected from the structures allowing the confined beam to leak out of the plane, propagating in a direction opposite the incident direction. The size, shape, and composition of the structures in the array determine the filter bandwidth, filter pass band profile, and center wavelength.

Wave-guide resonant structures readily produce filters that operate in reflection. To produce a transmission filter, wave-guide resonant structures are placed between highly reflecting broad-band mirror structures in a classic Fabry-Perot resonant cavity configuration. This concept is directly analogous to placing a solid etalon within a laser cavity to produce narrow line width, long coherence length, or as it is known in the art, “single-frequency” operation. Thin-film transmission filters create Fabry-Perot cavities using stacks of non-absorbing dielectric materials. A cavity resonance is obtained for light propagating in the longitudinal direction. In contrast, structural wave-guide resonant filters are configured to create a resonance in both the longitudinal and transverse directions, effectively reducing the number of layers required to achieve narrow-band transmission. Waveguide resonant transmission filters are disclosed by Magnusson in U.S. Pat. No. 5,598,300, and an all structural waveguide resonant transmission filter design is shown by Hobbs in reference (Hobbs, D. S. “Laser-Line Rejection or Transmission Filters Based on Surface Structures Built on Infrared Transmitting Materials”, Proceedings SPIE Vol. 5786, Window and Dome Technologies and Materials IX, March 2005)

When the features in a surface structure waveguide filter are configured with a high degree of circular symmetry, the light propagating in the structural waveguide will encounter the same reflection in all directions and will reflect light out of the waveguide without regard to the polarization state of the illuminating light. This polarization independence is one of the primary aspects of the devices disclosed by Hobbs and Cowan in U.S. Pat. Nos. 6,707,518, 6,791,757 and 6,870,624.

Surface structure waveguide filters that operate on polarized light can therefore be constructed using asymmetric structures such as a one-dimensional array of lines (a grating) or a two-dimensional array of rectangular features. In U.S. Pat. No. 5,598,300, Magnusson states that the waveguide resonant filters disclosed can be used as polarized filters, and non-Brewster angle polarized laser mirrors. Magnusson does not teach how a surface structure waveguide filter can operate on polarized light, or how such a filter can serve as a polarizer of a non-polarized light source containing a broad spectral content.

### SUMMARY OF THE INVENTION

In the following specification, polarizing surface structure waveguide filters are disclosed. The filters serve to transmit a specific polarization state for a given range of wavelengths while reflecting the orthogonal polarization state. This effect is created by a surface structure waveguide that is composed of asymmetric features such as an array of lines. The features of the structural waveguide will resonate with one wavelength of light that is polarized parallel to the grating lines, and with another wavelength of light that is polarized in a direction perpendicular to the grating lines. The same effect would be produced with a two-dimensional array of structures where the individual features are asymmetric such as rectangles, or where the structure spacing of the array is different in one direction than the structure spacing in the orthogonal direction. When the illuminating source contains a narrow range of wavelengths as with laser or light emitting diode (LED) light sources, a polarizing surface structure waveguide filter can be configured to transmit or reflect polarized light that matches the laser or LED wavelength. The same filter illuminated by a randomly polarized broad-band light source will reflect or transmit two narrow-band spectral regions that are polarized with orthogonal states. By designing an asymmetric surface structure waveguide filter that operates on multiple wavelength bands simultaneously, a polarizing multi-band filter can be realized that is capable of polarizing the discrete spectral content of the typical fluorescent lamp and LED light sources used to illuminate liquid crystal displays. This inventive device combines the benefits of simple inexpensive manufacturing found with surface relief microstructure optical retarders and waveguide resonant filters, with the low-loss large-area polarizing function found with stretched dielectric film stacks.

A multiple band matched filter device is particularly sensitive to the angle of incidence of the illuminating light. Depending on the structural waveguide configuration, the range of illumination angles can be as low as a few degrees off the design axis. For applications requiring illumination with a wide angular spread, or cone of light, a transmission filter would be a better choice. Waveguide resonant surface structure transmission filters are created when a structural waveguide layer is located between highly reflecting layers, either structured or uniform, creating a Fabry-Perot cavity. Only light that resonates within the cavity formed by the highly reflecting structural and/or uniform waveguide layers will be transmitted. With asymmetric structures forming the waveguide, only S-polarized light within a narrow range of wavelengths will satisfy the resonance condition and be transmitted. S-polarized light with a wavelength that is not resonant within the cavity will be reflected back in a direction opposite the illuminating beam direction. With P-polarized light a resonant cavity is not created and broad-band P-polarized light will be transmitted. For P-polarized light within a narrow-range of wavelengths, a resonance within the surface structure waveguide is created, and these wavelengths are reflected back superimposed upon the S-polarized reflected beam. The illuminating light that is not resonant with either the microstructures or the resonant cavity setup by the microstructure configuration, is polarized over a broad range of wavelengths. Therefore in contrast with the previously described polarizing matched rejection filters that produce polarizing color filters with resonant bands that match the spectral content of a particular illumination source, a transmission filter design calls for locating the resonant bands at light wavelengths that are not emitted by the source. As a consequence to create a broad-band reflective polarizer based on microstructures, it becomes desirable to minimize the bandwidth of the light that resonates with the microstructures, and to even introduce waveguide defects that effectively suppress or minimize the resonances leaving only the broad-band polarizing function. With minimized coherence between microstructured waveguide layers, the three dimensional structure can be envisioned as a bulk material with an average refractive index that varies with all three axes. The nature of microstructured waveguides produces a large index variation that allows a very small number of layers to perform an equivalent function to devices built with a large number of layers and a small index variation.

A large application for a non-absorbing broad band microstructured reflective polarizer is found in the back lights used to illuminate LCDs. As described above LCDs employ absorptive polarizers that selectively absorb all light of one polarization state. A non-absorbing reflective polarizer based on microstructures would provide a significant increase in LCD brightness by replacing the absorbing polarizers with an efficient polarizer that reflected the unwanted polarization state back into the light source where it would undergo polarization conversion and be recycled as transmitted light. The microstructures would allow the low cost high-volume manufacturing of such a polarizing film that could effectively compete in the one billion dollar reflective polarizer market currently enjoyed exclusively by the 3M company with their DBEF product.

One aspect of the present invention involves a guided-mode resonance surface structure optical filter that simultaneously filters and polarizes a narrow-range of light wavelengths contained within a broad-band light source. The surface structure polarizing filter provides high efficiency, reflecting or transmitting polarized light without loss due to absorption as found in conventional polarizing devices and color filters. Low cost manufacturing is also afforded through replication of the surface relief structures comprising the polarizing filter.

Another aspect of the present invention is directed towards a polarizing optical filter array having multiple guided-mode surface structures to reflect or transmit polarized light in one or more discrete bands of light wavelengths from a broad spectrum of incident light. The surface structures filters are confined to a predetermined region, with each region separated spatially by a predetermined distance, and with the regions repeated in a two-dimensional array. Each filter region or “window” in the array is configured to polarize and reflect or transmit a different wavelength of light. For example, an array consisting of repeated groups of three filter windows that transmit polarized red (R), green (G), and blue light (B) respectively, would form an RGB color filter array similar to that used in most liquid crystal displays. Such a polarizing RGB filter array would replace both the standard absorptive dye color filter arrays and the reflective polarizing film used in a modern LCD. An alternative embodiment of the polarizing transmission filter array would reflect polarized RGB light to produce the cyan (C), magenta (M), yellow (Y), or CMY color scheme used in most digital camera systems. Another alternative embodiment of the polarizing filter array would reflect polarized light within a narrow range of wavelengths out of the broad spectrum of infrared light to produce color and polarization discriminating imaging sensors for night vision applications.

Another aspect of the present invention is directed towards a polarizing optical filter having one or more guided-mode surface structures to reflect or transmit polarized light in one or more discrete bands of light wavelengths from a broad spectrum of incident light. The surface structures are arranged, or stacked, such that the illuminating broad-band light encounters each filter in series as it propagates. Each filter in the stack is designed to polarize and reflect or transmit a narrow-band of wavelengths that matches a spectral component of the illuminating source. Each filter in the stack covers an area at least as large as the illuminating light source. For example, three polarizing surface structure filters that polarize and reflect or transmit red (R), green (G), and blue light (B) respectively, could be layered to form an RGB color filter sheet where the RGB filters are set to match the spectral content of the light sources used in most liquid crystal displays. Such a polarizing filter sheet would be a low-cost competitor to the 3M reflective polarizer film described above.

Another aspect of the present invention is directed towards a polarizing optical filter having a single guided-mode surface structure that simultaneously reflects or transmits polarized light in two or more discrete bands of light wavelengths from a broad spectrum of incident light. In this embodiment, the dimensions of the structures that form the guided-mode filter are adjusted to support more than one resonant wavelength. Generally, between two and five discrete wavelength bands can be polarized and reflected or transmitted from a single surface relief structure. By matching the spectral distribution of the illuminating light source to the resonances of a surface structure filter, a high efficiency polarizer is provided that can operate on the light sources typically employed in liquid crystal displays. In the same manner, a polarizing surface structure filter can be constructed to reflect or transmit a particular spectral distribution that matches the signature of a target of interest, such as the infrared light signature of a rocket plume or jet engine, or a purposely encoded light source carrying information at discrete wavelengths and/or discrete polarization states such as with laser communications systems.

These aspects are generally achieved by providing a guided-mode surface structure filter that is formed of dielectric bodies of various predetermined shapes such as lines, or elliptical or rectangular posts or holes repeated over the surface of a substrate and arranged in a predetermined asymmetrical pattern such as with a grating or a rectangular or right-triangular array. It is noted that the term “body” as used herein may include “holes” filled with air or some other dielectric material.

In another application, a reflective polarizing surface structure optical filter could be used as a laser cavity mirror, or a transmissive filter could be built onto the facets of the lasing medium. Both filters would offer the particular advantage of high transmission of the pump light illumination combined with narrow-band reflection of the laser light. In addition, the filters can be constructed from the lasing medium itself to reduce thermal lensing problems and the thermal damage typically found with multiple-layer thin-film filters used with high power lasers.

In another application, surface structure filters can be provided that contain both polarizing and non-polarizing structures. Information could be carried on a broad-band light beam passed through the filter encoded at a predetermined wavelength and polarization state. Multiple predetermined wavelength bands could be exploited.

In still another application, polarizing surface structure filters can be provided to enhance the signal discrimination in a laser communications system. Amplitude modulated information could be encoded on one or more polarization states of a laser light source. For example, a free-space laser communication system between Earth and Mars could employ polarized light and polarizing narrow-band filters to support communication for an extended time as the orbit of Mars relative to the Earth causes an increase in background light from the Sun.

This invention features an apparatus for filtering and polarizing electromagnetic waves, the apparatus comprising a first substrate having a surface relief structure containing at least one dielectric body with physical dimensions smaller than the wavelength of the filtered electromagnetic waves, such structures repeated in a one or two dimensional array covering at least a portion of the surface of the first substrate, and said surface relief structures of the substrate being composed of or immersed in a material sufficient to form a guided mode resonance filter, and said dielectric bodies configured with unequal dimensions as observed in a plane parallel to the plane containing the substrate, or where the repeat period of said dielectric bodies in one direction of the two dimensional array is not equal to the repeat period in the orthogonal direction.

The dimensions of the surface relief structures can be adjusted to filter and polarize more than one wavelength range of electromagnetic waves. The wavelength ranges of filtered electromagnetic waves can correspond with the wavelength distribution of a cold cathode fluorescent lamp, or with the wavelength distribution of an LED light source. The individual dielectric bodies in the surface texture may be lines repeated in an array over the substrate surface. The individual dielectric bodies may have conical, elliptical, square, rectangular, sinusoidal, hexagonal, or octagonal cross sectional profiles. The individual dielectric bodies in the surface texture may be rectangular or elliptical posts or holes repeated in an array over the substrate surface. The individual dielectric bodies may have conical, elliptical, square, rectangular, sinusoidal, hexagonal, or octagonal cross sectional profiles.

The apparatus may further comprise one or more substrates containing such surface relief structures, the surface relief structures on each substrate configured to filter and polarize different wavelength regions from the illuminating electromagnetic waves, and said substrates superimposed such that the illuminating electromagnetic waves are filtered by each substrate in series. Alternatively, the apparatus may further comprise localized regions on each substrate containing such surface relief structures, the surface relief structures within each localized region configured to filter and polarize different wavelength regions from the illuminating electromagnetic waves, and said localized regions repeated in an array covering the substrate such that different regions of the illuminating electromagnetic waves are filtered by different localized regions simultaneously in parallel.

Also features is an LCD display, comprising a light source, a reflective polarizer that selectively transmits light from the light source with one polarization state and reflects light with the orthogonal polarization state, and a liquid crystal module that receives the light transmitted by the reflecting polarizer, the liquid crystal module comprising a polarizing array as set forth above. Also featured is a laser cavity mirror comprising the apparatus described above. Still further, the invention features an optical encoding device, comprising a light source and an apparatus as described above that receives the light from the source and reflects light at at least one wavelength and having one polarization state, and transmits light at least one other wavelength and having the orthogonal polarization state.

Another aspect of the invention features a polarizing color filter, comprising an array of separate pixels, each pixel comprising a plurality of discrete color filter windows that each transmit a different narrow portion of the visible light spectrum, each window comprising an apparatus as described above. Still another aspect contemplates a polarizing filter comprising the apparatus described above having a waveguide defined by a uniform layer of a material with a first index of refraction, and the surface relief structure made of a material having a second index of refraction, in which the first index of refraction is substantially greater than the second index of refraction

These advantages of the present invention will become more apparent from the following specification and claims.

### BRIEF DESCRIPTION OF THE DRAWINGS

FIG. 1 is a schematic diagram of a polarizing optical filter device designed to operate on near infrared light according to certain principles of the present invention.

FIG. 2 is a plot of the predicted reflection of the polarizing optical filter model shown in FIG. 1.

FIG. 3 shows Scanning Electron Microscope (SEM) images of a prototype polarizing optical filter device fabricated according to the model shown in FIG. 1.

FIG. 4 is a plot of the measured reflection of the polarizing optical filter device shown in FIG. 3.

FIG. 5 is a plot of the measured reflection of an improved polarizing optical filter device constructed to closely match the design shown in FIG. 1.

FIG. 6 is a schematic diagram of a polarizing optical filter device designed to operate on green light according to certain principles of the present invention.

FIG. 7 is a plot of the predicted reflection of the polarizing optical filter model shown in FIG. 6.

FIG. 8 is a composite plot showing the predicted reflection of two polarizing optical filter devices operating on blue and red light according to certain principles of the present invention.

FIG. 9 is a diagram showing a plan view of a repeating array of color filters according to principles known in the art.

FIG. 10 is a plot showing the transmission of discrete color filters typically used in liquid crystal display devices.

FIG. 11 is a diagram depicting the cross section of a back side illuminated liquid crystal display.

FIG. 12 shows two plots of the spectral distribution of the light sources used to illuminate liquid crystal displays.

FIGS. 13a and 13b show SEM images of prototype polarizing optical filter devices fabricated according to the model shown in FIG. 6.

FIG. 14a is a plot of the measured reflection of the polarizing optical filter device shown in FIG. 13a.

FIG. 14b is a plot of the measured reflection of the polarizing optical filter device shown in FIG. 13b.

FIG. 15a is a diagram illustrating the design of discrete polarizing color filters that form one pixel in a color and polarization discriminating device according to certain principles of the present invention.

FIG. 15b is a schematic diagram illustrating the continuous replication of the FIG. 15a polarizing color filters using methods known in the art.

FIG. 16 is a schematic diagram of a polarizing optical filter device designed to operate on blue and green light simultaneously according to certain principles of the present invention.

FIG. 17 is a plot of the predicted transmission of the polarizing optical filter model shown in FIG. 16.

FIG. 18 is a schematic diagram of a polarizing optical filter device designed to operate on red, green, and blue light simultaneously according to certain principles of the present invention.

FIG. 19 is a plot of the predicted reflection of the polarizing optical filter model shown in FIG. 18.

FIG. 20 is a plot of the measured reflection from a prior art non-polarizing optical filter illustrating certain principles of the present invention.

FIG. 21 is a schematic diagram of a polarizing optical filter device designed to operate on visible light according to certain principles of the present invention.

FIG. 22 is a plot of the predicted reflection of the polarizing optical filter model shown in FIG. 21.

FIG. 23 shows multiple schematic diagrams of alternate configuration polarizing optical filter devices designed to operate on visible light according to certain principles of the present invention.

FIG. 24 is a schematic diagram of a polarizing optical filter device designed to operate simultaneously on multiple bands of blue and green light according to certain principles of the present invention.

FIG. 25 is a plot of the predicted transmission of the polarizing optical filter model shown in FIG. 24.

FIG. 26 is a schematic diagram illustrating a method for the continuous high-volume replication of the polarizing optical filter device shown in FIG. 24.

FIG. 27 is a schematic diagram of a polarizing optical filter device designed to operate simultaneously on multiple bands of red and green light according to certain principles of the present invention.

FIG. 28 is a plot of the predicted transmission of the polarizing optical filter model shown in FIG. 27.

FIG. 29 is a plot of the predicted transmission of the polarizing optical filter model shown in FIG. 27, configured to operate on blue light according to certain principles of the present invention.

FIG. 30a is a plot of the predicted transmission of a plastic film coated with three uniform material layers as illustrated by the inset cross sectional diagram.

FIG. 30b is a schematic diagram illustrating a method for the continuous high-volume replication of the polarizing optical filter device shown in FIG. 27.

FIG. 31 is a plot of the predicted transmission of an improved polarizing optical filter model based on the model shown in FIG. 27.

FIG. 32 is a plot of the predicted reflection of an improved polarizing optical filter model based on the model shown in FIG. 27.

FIG. 33 is a plot of the predicted transmission through two polarizing optical filters of the FIG. 27 design according to certain principles of the present invention.

FIG. 34 is a plot of the predicted transmission through two polarizing optical filters of the FIG. 27 design according to certain principles of the present invention.

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

### DETAILED DESCRIPTION OF THE INVENTION

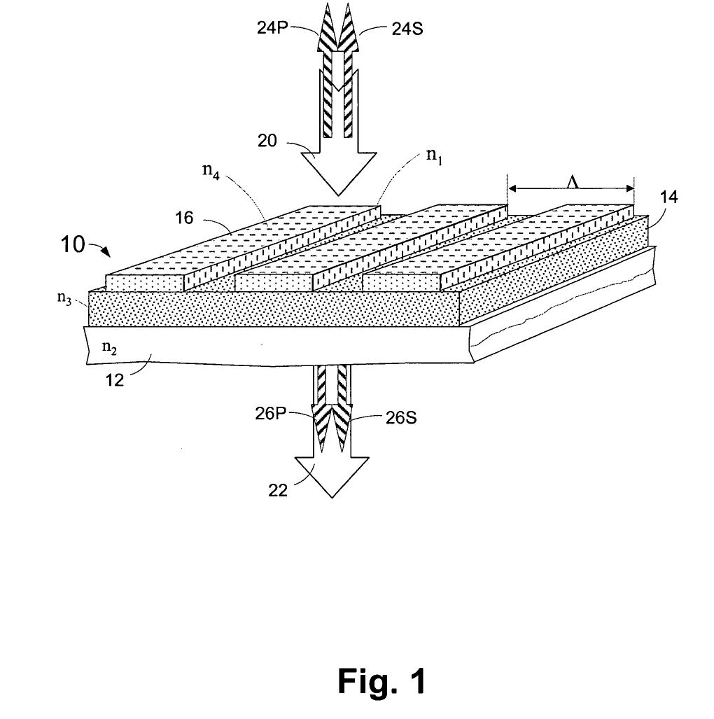

FIG. 1 shows a perspective view with cross section of a surface structure polarizing optical filter 10 capable of reflecting light of a particular range of wavelengths and a particular electric field orientation 24P and 24S, or polarization state, out of a broad spectrum, randomly polarized light beam 20 striking the device at normal incidence. Transmitted light beam 22 contains the same randomly polarized broad spectrum light as incident beam 20 except for wavelengths 26P and 26S that propagate with an electric field orientation orthogonal to reflected light 24P and 24S. Note that the use of the identifiers ‘S’ and ‘P’ refer to orthogonal electric field orientations in all that follows, with S meaning an electric field vibrating parallel to the long dimension of the surface structures, and P designating an electric field vibrating in the orthogonal direction, or perpendicular to the long dimension of the surface structures.

The polarizing surface structure optical filter 10 is built upon a platform or substrate 12 with an optical index of refraction n2. The filter consists of a uniform material layer 14 with refractive index n3 and a surface relief structure 16 configured as an array of lines with a generally rectangular cross sectional profile made of a material with refractive index n4. The space between the lines 16 is filled with a material with refractive index n1. The lines 16 are repeated in an array across the surface of the uniform material layer 14 on substrate 12 with a periodic spacing, or pitch of Λ. The array of lines 16 is known in the art as a grating. To serve as an optical filter, the grating pitch must be less than the wavelength of the light to be filtered. Such a grating is referred to as ‘sub-wavelength’ in the art. In addition, the polarizing filter 10 must be fabricated with materials that form a waveguide. This requires that the refractive index of the material layers are such that n2<n3>n1, and n3≧n4.

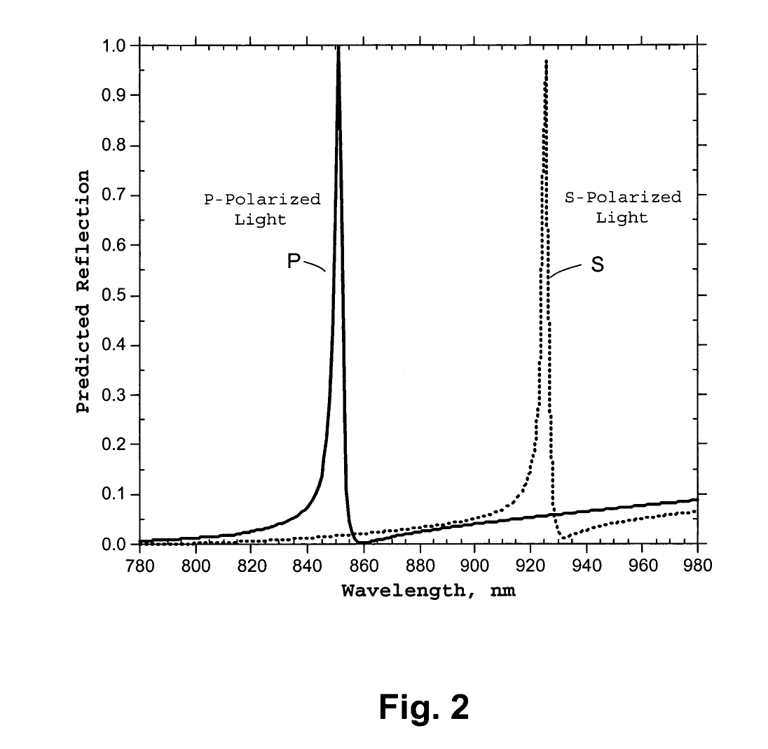

The performance of the polarizing surface structure optical filter design 10 is simulated using a rigorous vector diffraction calculation. The software simulation predicts the spectral reflectance and transmittance of broad spectrum light through a user defined three-dimensional surface texture composed of multiple structured and uniform materials. The calculation accounts for arbitrary polarization states and light incident angles. Measured data for the optical constants of a library of materials is included. FIG. 2 shows a plot of the predicted performance of the polarizing filter design shown in FIG. 1. The model employed tantalum pentoxide (Ta2O5) with n3=2.1 for material layer 14, a photosensitive polymer with n4=1.62 for grating lines 16, a glass substrate with n2=1.48, and an environment of air with n1=1. The grating pitch, Λ, was set to 550 nm, and the width and height of the grating lines was set at 275 nm and 90 nm respectively. The thickness of the Ta2O5 layer 14 was set at 150 nm. When a broad-band light beam 20 is incident perpendicular to the plane of the filter structures, the model predicts that P-polarized light with a wavelength of 850 nm will be reflected as light beam 24P, and that S-polarized light with a wavelength of 925 nm will be reflected as light beam 24S. Transmitted broad-band light beam 22 will contain S and P polarized spectral components 26P and 26S at wavelengths 850 nm and 925 nm respectively. The device 10 serves as a wavelength and polarization filter. FIG. 2 depicts that the potential efficiency of the polarizing function approaches 100%, i.e. 100% of the P-polarized light at a wavelength of 850 nm contained within light beam 20 will be reflected. When light beam 20 is not polarized, device 10 will reflect 50% of the light at 850 nm into the P polarization state, and transmit 50% of the light at 850 nm into the S polarization state. At a wavelength of 925 nm, half of the light will be reflected into the S polarization state, and the other half will be transmitted in the P polarization state.

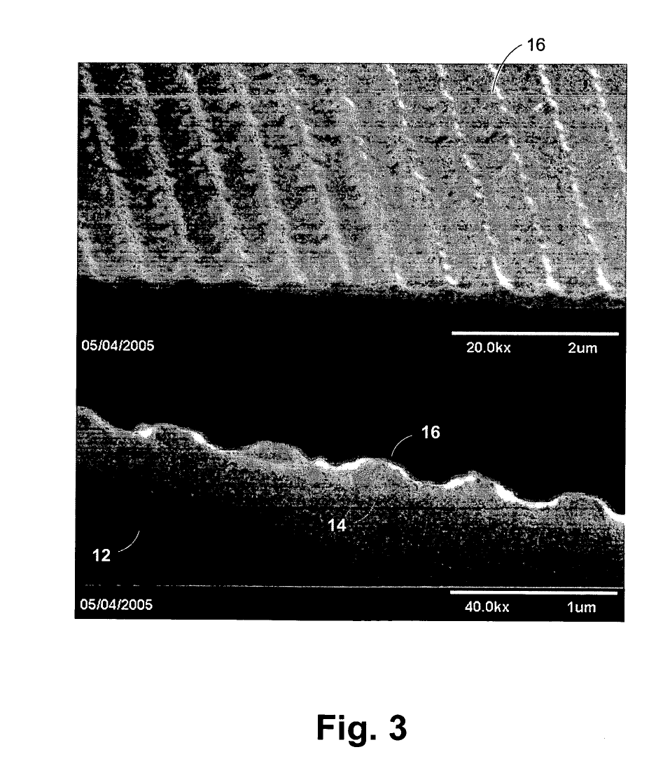

A prototype of the FIG. 1 polarizing filter design was fabricated to demonstrate the polarizing effect. Glass substrates coated with a 150 nm layer of Ta2O5 were coated with an 80 nm thick layer of the photosensitive polymer known as photoresist. The photoresist was exposed with a grating pattern with a pitch of 530 nm using the technique of interference lithography. After a standard wet development process the photoresist layer contained a surface structure consisting of an array of lines. Elevation and cross sectional views of the fabricated structure are shown in the scanning electron microscope (SEM) images of FIG. 3. The substrate 12, uniform material layer 14, and grating lines 16 are indicated in the micrographs.

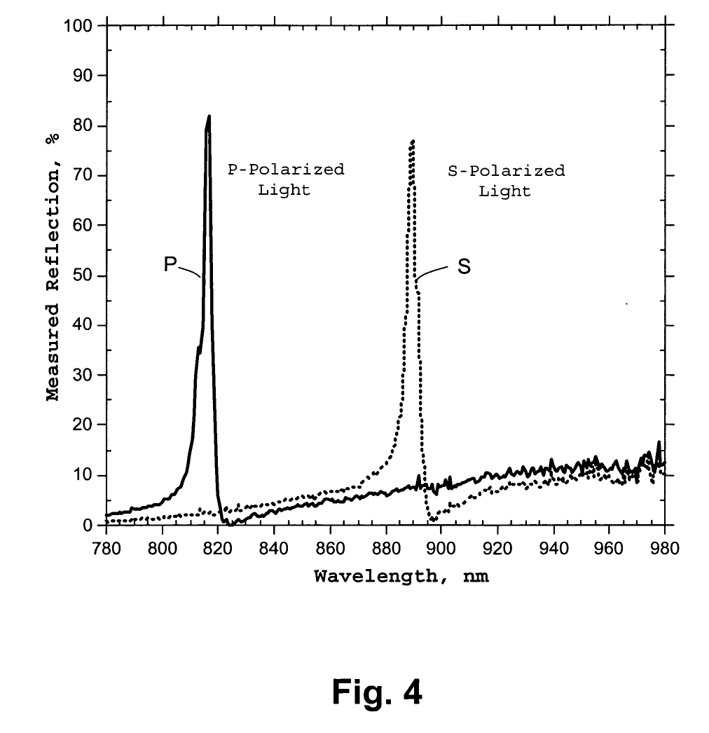

FIG. 4 is a plot of the measured reflection of the polarizing filter prototype shown in FIG. 3. Two curves are shown where the dashed line shows the reflection from the device when illuminated with S polarized broad band light at normal incidence, and the solid line shows the reflection from the device when illuminated with P polarized broad band light also at normal incidence. The measurement was made using a fiber-coupled light source and grating-based spectrometer referenced to an aluminum mirror. The polarization efficiency is about 80% for both polarizing wavelength bands, and the band separation is 75 nm. The shape, position, and separation of the polarizing filter bands is a close match to that predicted by the FIG. 2 calculation.

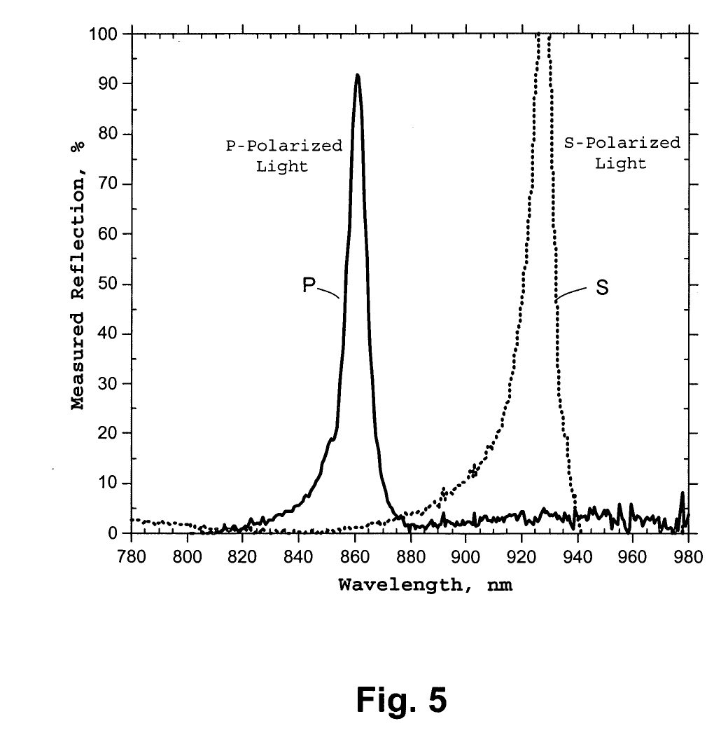

FIG. 5 is a plot of the measured reflection of a polarizing filter prototype fabricated with a grating structure that closely matches the FIG. 1 design. As in FIG. 4, two curves are shown where the dashed line shows the reflection from the device when illuminated with S polarized broad band light at normal incidence, and the solid line shows the reflection from the device when illuminated with P polarized broad band light also at normal incidence. The spectrometer measurement shows a polarization efficiency of 102% for S-polarized light centered at 925 nm, and an efficiency of about 95% for P-polarized light centered at 860 nm. (The error in efficiency measurements is due to the variation in transmission of the conventional absorptive polarizer used to polarize the white light source.) The shape, position, and separation of the polarizing filter bands is a good match to that predicted by the FIG. 2 calculation, and the polarization efficiency is high indicating minimal light loss due to scattering from or absorption by the filter materials.

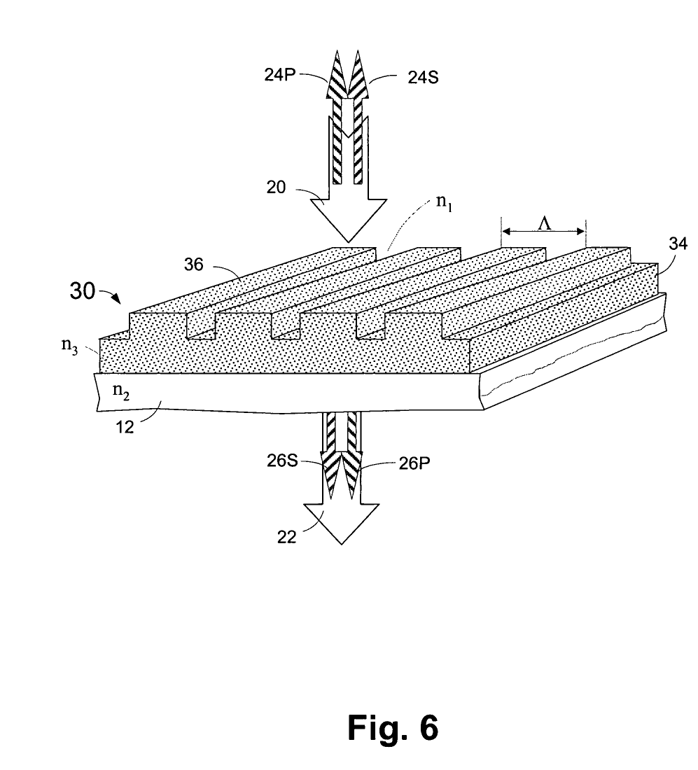

For many applications such as the color filter arrays and reflective polarizers used in LCDs, it is desirable to produce a filter response over a wider wavelength band to match the spectral content of the light source. In addition, producing a polarizing filter function with fewer material layers would yield significantly reduced manufacturing costs compared to the costs associated with the hundreds of material layers required by the dominant reflective polarizer technology. FIG. 6 shows a polarizing filter structure 30 designed to operate on green light centered at 540 nm, a common wavelength emitted by cold cathode fluorescent lamps (CCFL) and light emitting diodes (LED) used in LCDs. The device 30 consists of a single material layer 34 supported by substrate 12 and containing surface relief structures 36. Such a structure could be readily fabricated on flexible plastic substrates using conventional, high-volume, roll-to-roll replication methods. As with device 10, to act as a polarizing filter, device 30 is constructed of materials that conform to the relationship n1<n3>n2, the pitch, Λ of the surface relief structures 36 must be less than the wavelength of light to be filtered, and the surface relief structures 36 must be configured with a high degree of asymmetry to generate a polarizing effect.

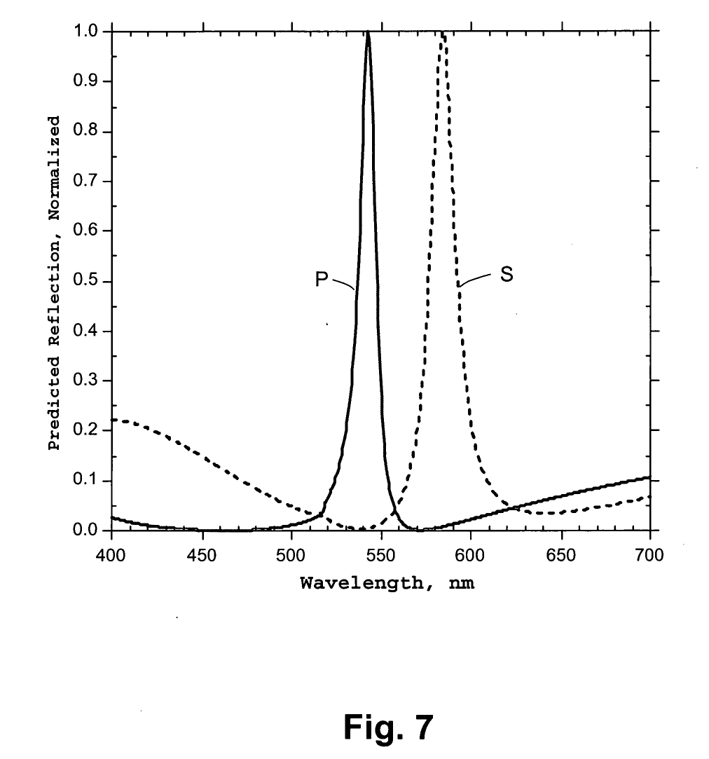

FIG. 7 shows the predicted reflection from the polarizing filter design of FIG. 6. As with the previous plots and all subsequent plots below, two curves are shown where the dashed line shows the predicted reflection from the FIG. 6 model when illuminated with S polarized broad band light at normal incidence, and the solid line shows the predicted reflection from the FIG. 6 model when illuminated with P polarized broad band light also at normal incidence. The model employs Ta2O5 (n3=2.1) for the combined material and structural layers 34 and 36, a glass substrate with n2=1.48, and an environment of air with n1=1. The grating pitch, Λ, was set to 350 nm, and the width and height of the grating lines 36 was set at 175 nm (half the pitch, or a 50% duty cycle) and 75 nm respectively. The thickness of the Ta2O5 layer 34 was set at 75 nm. When a broad-band light beam 20 is incident perpendicular to the plane of the filter structures, the model predicts that S-polarized light with a wavelength of 585 nm will be reflected as light beam 24S, and that P-polarized light with a wavelength of 540 nm will be reflected as light beam 24P. Transmitted broad-band light beam 22 will contain S and P polarized spectral components 26P and 26S at wavelengths 585 nm and 540 nm respectively.

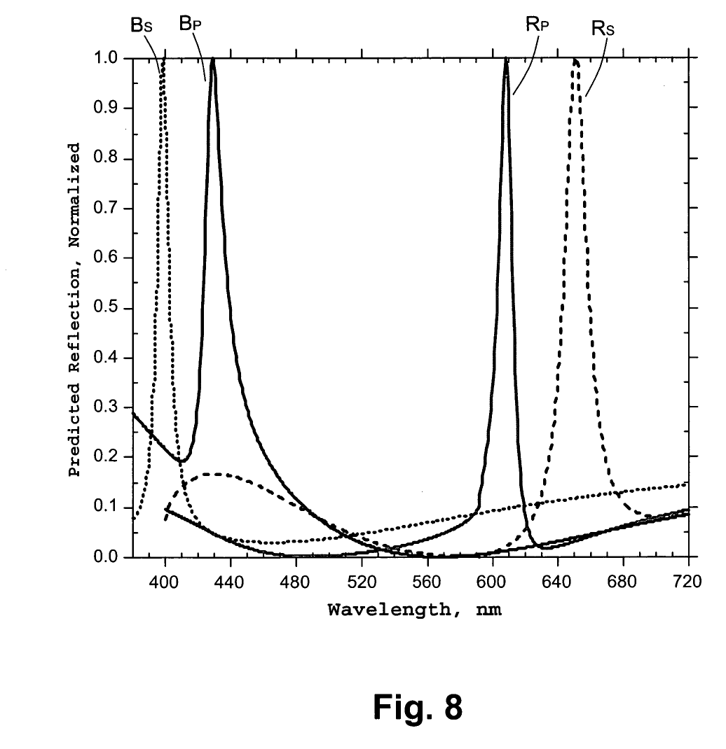

Device 30 functions as an efficient polarizer for two wavelength bands that are 15 to 20 nm wide measured at the full-width half-maximum (FWHM) point, and separated by 45 nm. The center wavelengths of the polarizing bands are predominantly determined by the pitch of the grating lines. FIG. 8 shows the predicted effect of changing the grating pitch to center the polarizing filter band at 430 nm in the blue and 610 nm in the red, both standard wavelengths emitted by CCFLs. Four curves are shown, two for the red filter model where the grating pitch was set to 400 nm, and two for the blue filter model where the grating pitch was set to 250 nm. All other device parameters were set as in the FIG. 6 model. The model results indicate that one type of structure composed of a fixed set of materials can be used to generate the red, green, and blue polarizing filter bands typical of the color filter arrays used in most LCDs and digital cameras. A pixelated master structure can then be produced where an array of pixels is constructed with three sub-regions each containing a different grating pitch. The master array can be fabricated using standard dot matrix interference lithography tools. A polarizing color filter array containing many hundreds of thousands of pixels can be replicated at one time onto a flexible plastic sheet using standard roll-to-roll replication techniques.

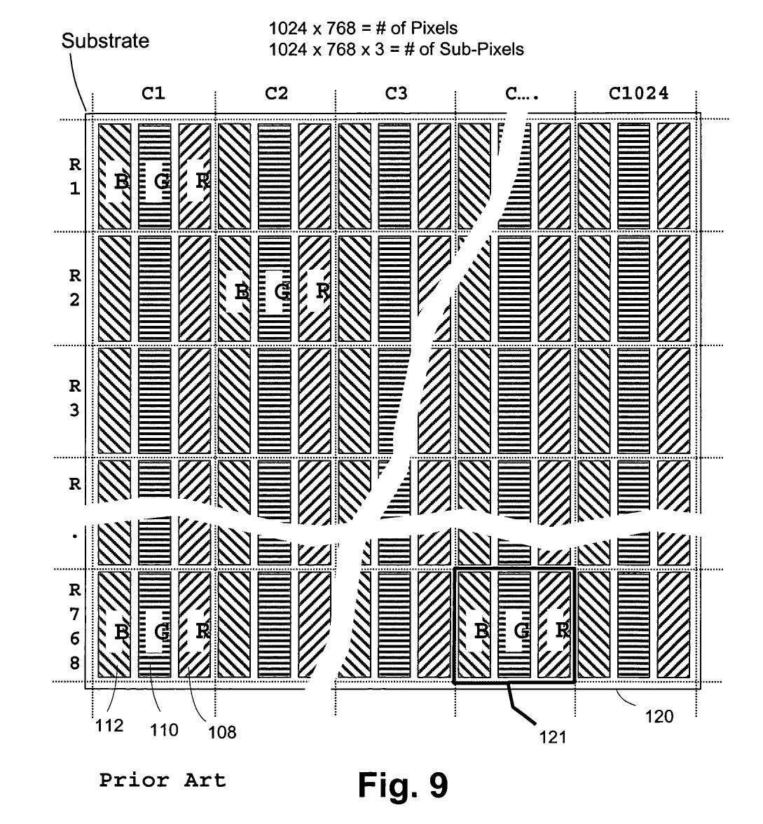

FIG. 9 depicts a plan view of a typical color filter array 120 configured with 1024 columns C1 to C1024 and 768 rows R1 to R768 of picture elements (pixels) 121 each containing a set of three color filter windows that transmit a narrow portion of the visible light spectrum corresponding to red R, green G, and blue B. Array 120 is a typical component of flat-panel LCDs such as used in laptop computers, desktop computer monitors, and televisions.

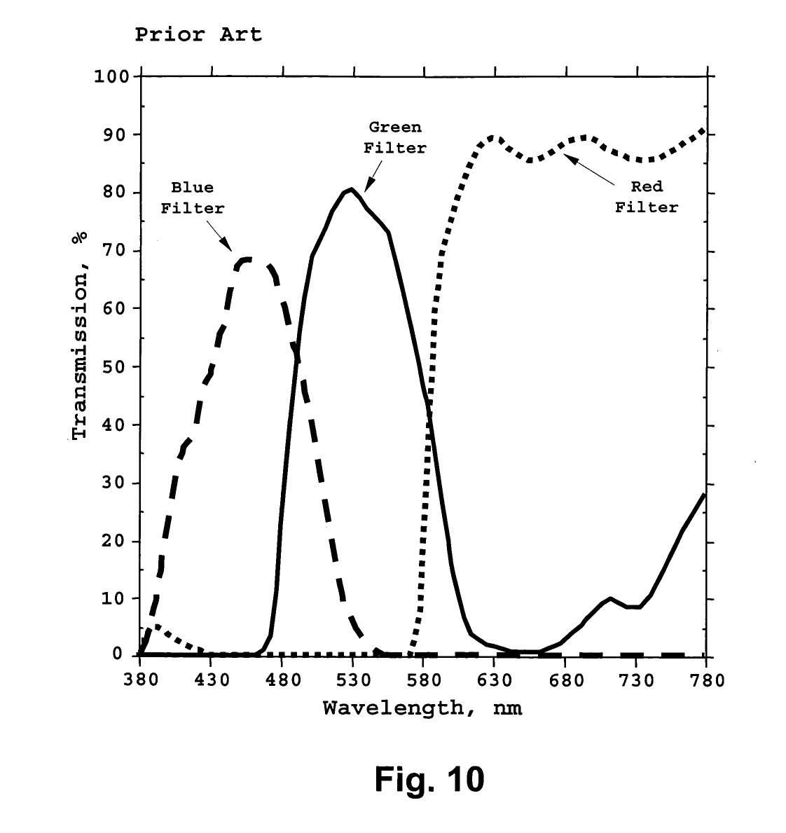

FIG. 10 shows the published transmission of visible to near infrared light (over the wavelength range of 380 to 780 nm) through the absorptive dye color filter materials produced by Dai Nippon Printing Company of Japan. Three curves are shown corresponding to the transmission of the red (dotted line), green (solid line), and blue (dashed line) materials used in most LCD color filter arrays. Each of the three materials consists of a uniform layer of hardened polymer containing dyes that transmit a narrow-band of wavelengths with minimal absorption, while strongly absorbing light with wavelengths outside the pass band. The pass band of each dye is optimized for a peak transmission to match the spectral distribution of the typical CCFL lamps used in LCDs. It is an object of the invention to replace the absorptive dye filters commonly employed in array 120 with non-absorbing and polarizing color filters that transmit or reflect a narrow range of wavelengths and recycle through reflection all wavelengths outside the color filter band.

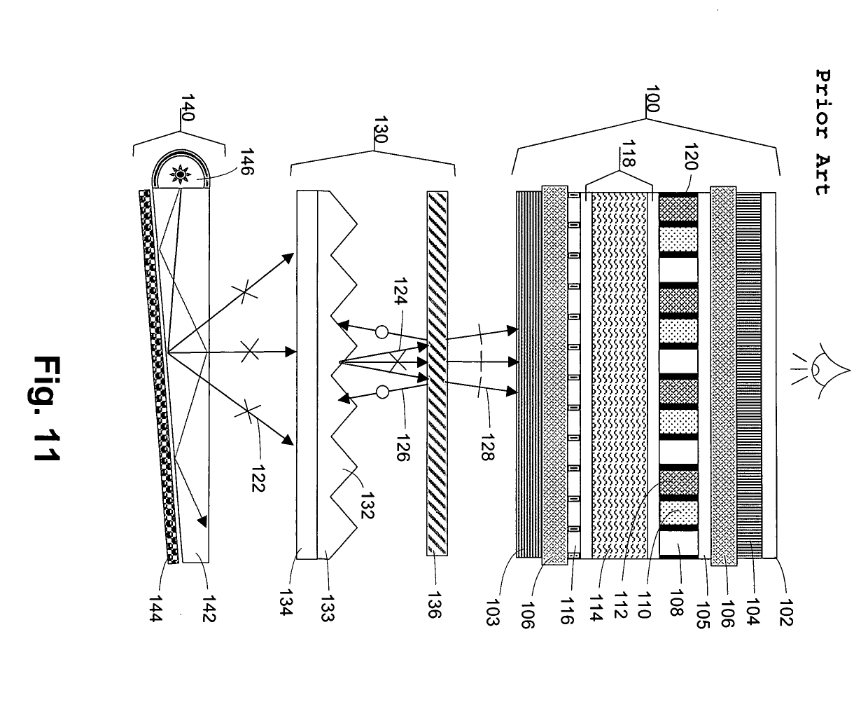

To further illustrate the application of the inventive devices, a schematic diagram showing a cross section of a typical back-side illuminated LCD is shown in FIG. 11. The LCD consists of the liquid crystal module 100, light shaping, distribution, and polarizing films 130, and light source 140. Light source 140 contains a CCFL lamp 146 (or alternatively an array of LEDs) and light guide 142 coupled to a light reflecting and diffusing surface 144. Unpolarized light 122 is spread out by the combination of 142 and 144 to cover the area of the display and to propagate toward liquid crystal module 100. Before reaching module 100, unpolarized light 122 that is emitted over a large range of angles encounters light collimating films 134 and 133 that serve to decrease that angular spread of the illumination producing a narrow cone of light 124. Films 134 and 133 are typically formed as triangular profile gratings 132 arranged in a crossed configuration. An alternate design utilizes an array of microlenses. These light collimating, or prism films, are often referred to as Brightness Enhancing Films, or BEF in the art.

Illuminating light 124 is unpolarized when it encounters reflective polarizer 136 that selectively transmits light 128 with a linear polarization state and reflects light 126 with the orthogonal polarization state. Such a reflective polarizer 136 serves to increase the light transmitted through module 100 by eliminating the absorption of light not polarized along the transmission axis of the liquid crystal module 100 (as described above), and by the eventual transmission of reflected light 126 that after multiple reflections from 133, 134, 142, and 144, is converted into polarized light 128 (an operation known as light recycling in the art). The function of reflective polarizer 136 should have little dependence on the color of the illuminating light, and should operate efficiently on light incident on axis and up to 30 degrees off-axis. As noted above, the 3M company supplies the dominant reflective polarizing film to the LCD market. 3M's film is known as DBEF. It is a further object of the invention to provide an alternative, non-absorbing, light recycling, broad-band polarizing film based on microstructures that can be mass-produced at low cost.

Polarized light 128 is next incident upon liquid crystal module 100 which is constructed of substrates 106 and liquid crystal material 114. Polarized light 128 is oriented with its polarization axis aligned with the transmission axis of conventional absorptive polarizing layer 103. The light 128 next propagates through an array of windows containing a transparent conducting film 116 that are connected to individual transistors to allow the application of an electrical signal as described above. Layers 118 serve to align the liquid crystal molecules in a ground state that can be altered by the electronic signal. After passing through layers 114 and 118, light 128 is incident upon color filter array 120 containing discrete red 108, green 110, and blue 112 filter windows. Polarized light with varying spectral content is transmitted by array 120 and propagates through transparent conductive layer 105 and through upper substrate 106. Depending on the electronic signal applied, the light transmitted by color filter array 120 will be polarized along either the transmission or the extinction axis of the absorptive polarizer layer 104. Light polarized parallel to the transmission axis of layer 104 will be transmitted through anti-reflection layer 102 where it can be observed.

It is a further object of the invention to provide an improved color filter array 120 based on polarizing array of microstructures that can be fabricated from materials that also provide the function of transparent conductive layer 105, external polarizer 104, and potentially alignment layer 118.

It is a further object of the invention to provide an alternative, non-absorbing, light recycling, broad-band polarizing film 136 based on microstructures that can be mass-produced at low cost, and can also provide sufficient polarizing efficiency to allow elimination of absorptive polarizer 103.

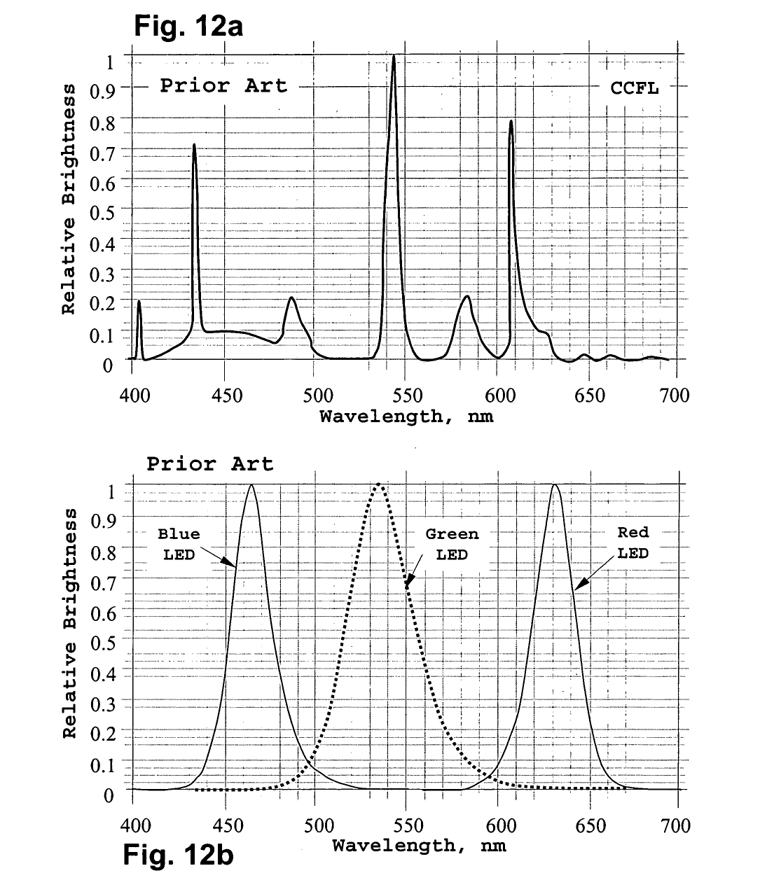

A particular objective of the invention is to provide a polarizing filter capable of operating on the illumination sources used with LCDs. FIGS. 12a and 12b show the spectral distribution of two light sources commonly employed to illuminate LCDs. FIG. 12a is a plot of the output of a CCFL backlight showing three narrow-band emission lines at 610 nm, 540 nm, and 430 nm. The spectral width of the phosphor emission lines is less than 3 nm FWHM for the blue and red lines, and about 10 nm FWHM for the green line. FIG. 12b is a composite plot of the spectral distribution of a backlight constructed using three LED sources centered at 630 nm, 535 nm, and 465 nm. The spectral width of each LED is between 25 and 40 nm FWHM.

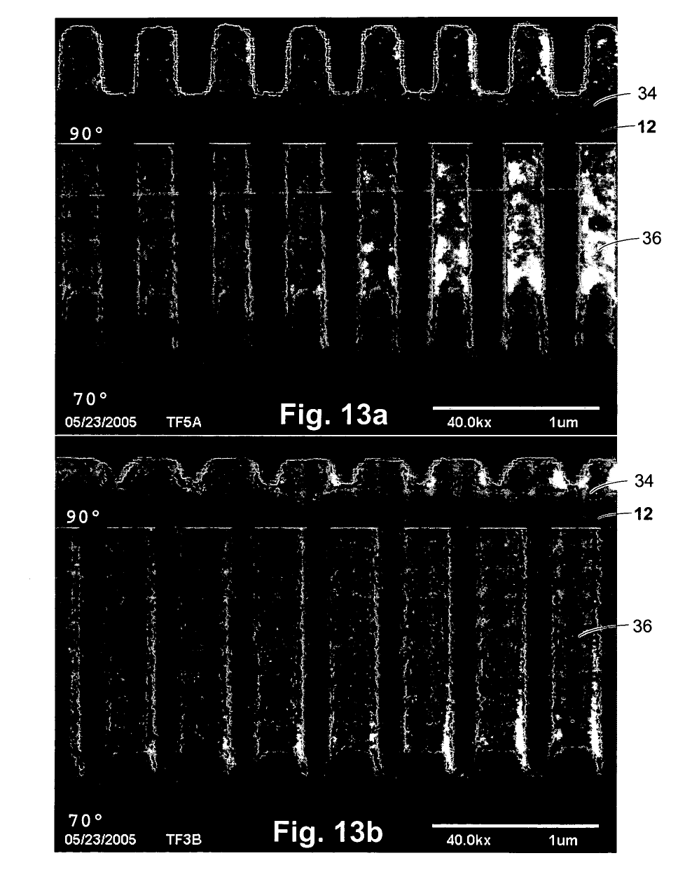

The FIG. 6 design for polarizing color filters was reduced to practice in the fabrication of several prototypes designed to extract polarized red light from a white light source. Glass substrates coated with a 150 nm layer of Ta2O5 were coated with a 385 nm thick layer of photoresist. The photoresist was exposed with a grating pattern with a pitch of 405 nm using the technique of interference lithography. After a standard wet development process the photoresist layer contained a surface structure consisting of an array of lines. The photoresist layer was then employed as a sacrificial mask through which the layer of Ta2O5 beneath was etched using the dry etching technique known as reactive ion etching, or RIE. Elevation and cross sectional views of the fabricated structure after RIE but before removal of the residual photoresist mask layer, are shown in the SEM images of FIG. 13a. The substrate 12, uniform material layer 34, and grating lines 36 are indicated in the micrographs. FIG. 13b shows a polarizing color filter prototype fabricated in a manner similar to the FIG. 13a prototype, except that the residual photoresist mask material has been removed.

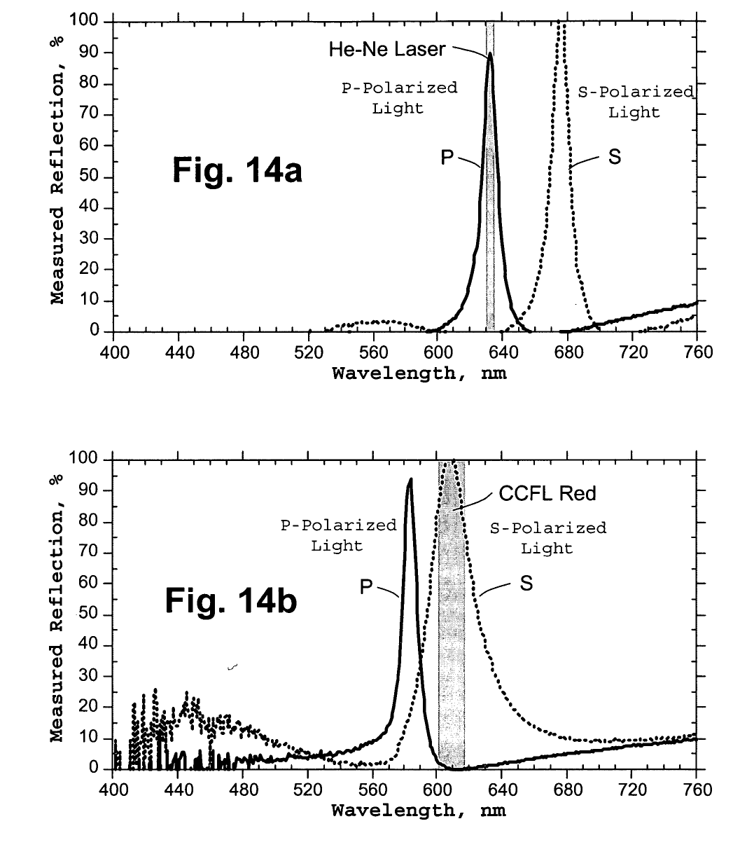

FIG. 14a is a plot of the measured reflection of the polarizing filter prototype shown in FIG. 13a. Two curves are shown where the dashed line shows the reflection from the device when illuminated with S polarized broad-band light at normal incidence, and the solid line shows the reflection from the device when illuminated with P polarized broad band light also at normal incidence. The measurement was made using a fiber-coupled light source and grating-based spectrometer referenced to an aluminum mirror. The polarization efficiency is above 90% for P-polarized light centered at 633 nm, a wavelength that corresponds to the emission of a common helium-neon gas laser. A polarization efficiency of 100% is observed for S-polarized light centered at 675 nm. The polarization extinction ratio, or contrast, at both bands is well over 200:1 with the actual value recorded being limited by the measurement system. The FIG. 14a prototype would make an effective laser cavity mirror, providing polarized feedback that could serve to stabilize the laser frequency and reduce the need for the typical Brewster windows.

FIG. 14b shows the polarizing efficiency of the FIG. 13b prototype. In this prototype the bandwidth has been increased significantly and the band has been centered at 610 nm to match the red emission from a CCFL source. Note that the reflection outside the band is minimal—meaning high transmission of blue and green light. Such a filter would correspond to cyan in the CMY color scheme.

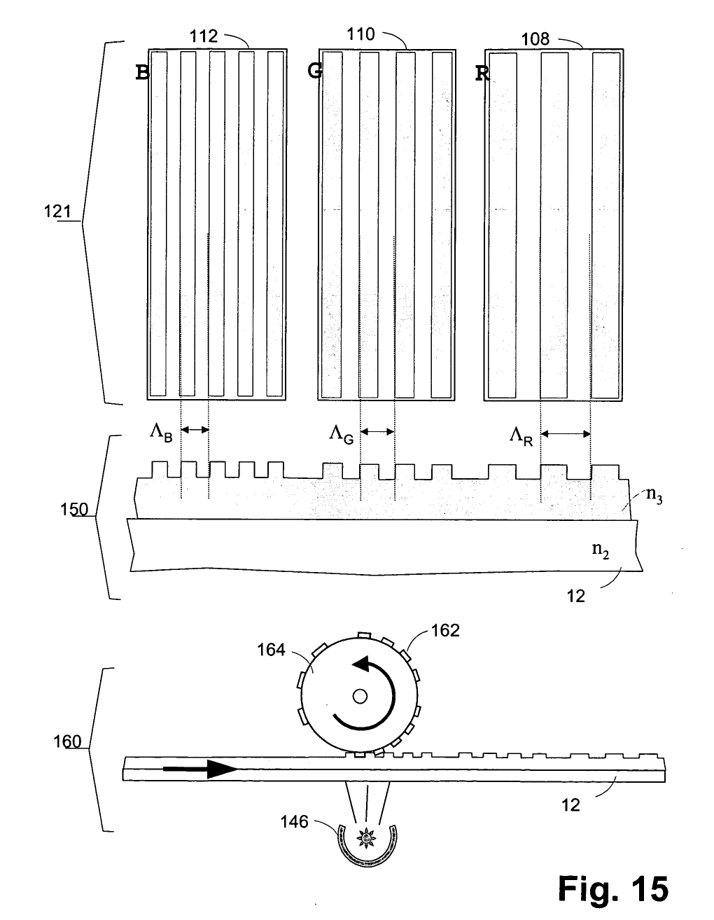

FIG. 15 illustrates the simple manufacturing method that can be employed to produce a microstructure based polarizing color filter array 120. One pixel 121 of the array is shown to consist of three sub-pixel windows corresponding to red, green, and blue reflection (or cyan, magenta, yellow transmission). A cross section 150 of the structure is shown where a material layer with refractive index n3, surrounded by an environment with index n1, is supported by a substrate with refractive index n2 such that n1<n3>n2. The design of the filters follows the FIG. 6 model where a structured layer is fabricated in a uniform material layer such that the depth of the structures is less than half the thickness of the material layer. The n3 refractive index material layer can consist of a high temperature polymer resin with index n3 in the range of 1.7 to 1.9. The substrate can be glass or plastic with an index of refraction in the range of from 1.4 to 1.65, with polyethylene, or PET sheet plastic film being a common choice for display films (n3=1.6). System 160 can be used to effect the continuous patterning of the color filter array in a single pass replication process employing a drum roller 164 containing protrusions 162 that serve to impress the pattern shown in 120 and 150 into the high index material. Alternatively the high index material may contain photo-initiators that allow the hardening (curing) of the material upon exposure to light source 146 which typically emits light in the ultraviolet to blue spectral range.

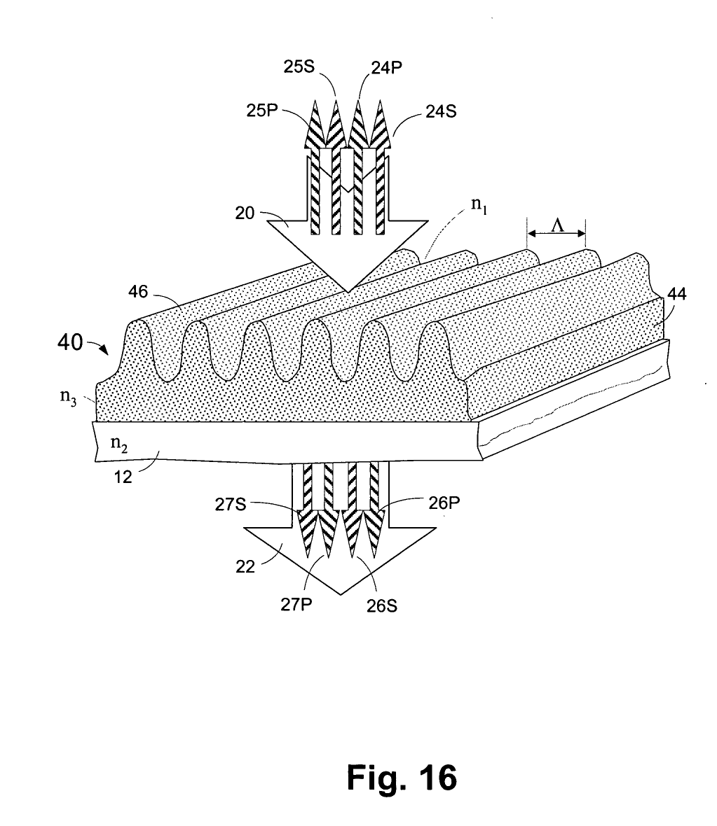

In many LCD applications, a polarizing filter must operate on as many as five discrete wavelength bands emitted by the illumination source. Through modification of the structure of the inventive device, a polarizing filter can be made to operate on many wavelength bands simultaneously. FIG. 16 shows polarizing optical filter device 40 designed to reflect and polarize both blue and green light simultaneously. A surface relief grating structure 46, consisting of sinusoidal profile lines is built into the surface of a material layer 44, supported by substrate 12. Again the refractive indices of the materials is set such that n1<n3>n2, a condition necessary to create the waveguide resonant effect. The depth and pitch of the grating structure 46 and the thickness of the uniform layer 44 are adjusted to accommodate multiple resonant bands. By increasing the thickness of layer 44 and grating 46 from about one quarter of the resonant wavelength as in the FIG. 6 design, to about three quarters of the resonant wavelength, two polarizing filter bands can be produced.

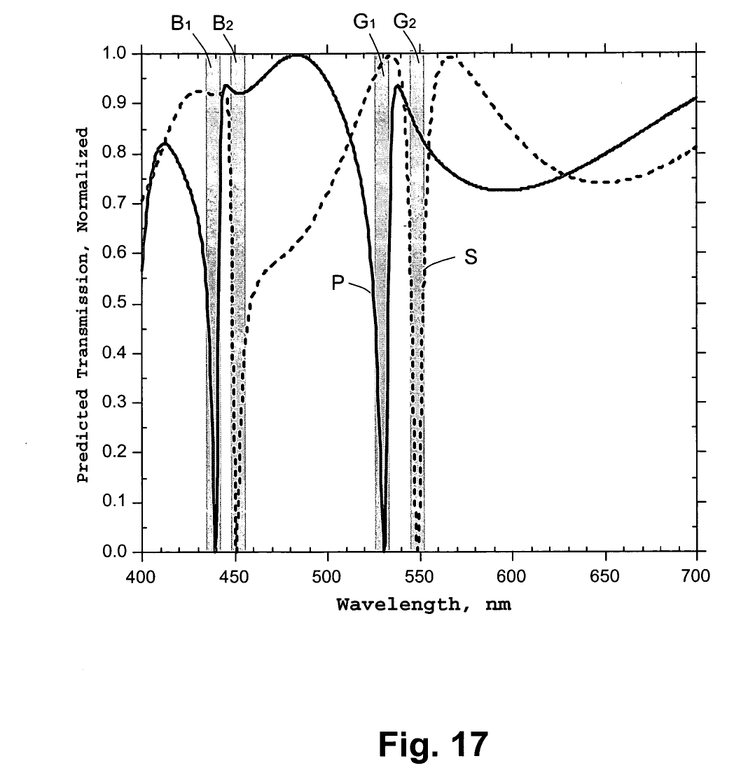

FIG. 17 shows the results of a calculation of the transmission through device 40 constructed with a glass substrate 12 (n2=1.48), and a structured layer of zinc sulfide 44,46 (n3=2.4) surrounded by air n1=1. The thickness of the uniform ZnS layer 44 is set to 180 nm, the grating depth is set to 195 nm, and the grating pitch is set to 253 nm. The solid curve in FIG. 9 shows that P polarized light with will be reflected out of a broad-spectrum light beam 20 at two wavelengths centered at 540 nm and 440 nm, as represented by 24P and 25P of FIG. 16 respectively. Only S polarized light, as represented by 26S and 27S of FIG. 8 is transmitted at wavelengths 540 nm and 440 nm. The dashed curve in FIG. 17 shows that S polarized light with will be reflected out of a broad-spectrum light beam 20 at two wavelengths centered at 550 nm and 450 nm, as represented by 24S and 25S of FIG. 16 respectively. Only P polarized light, as represented by 26P and 27P of FIG. 16 is transmitted at wavelengths 550 nm and 450 nm. The polarizing filter bands centered at wavelengths of 550, 540, 450, and 440 nm are highlighted by the shaded regions in FIG. 17 and are designated as G2, G1, B2, and B1 in the figure.

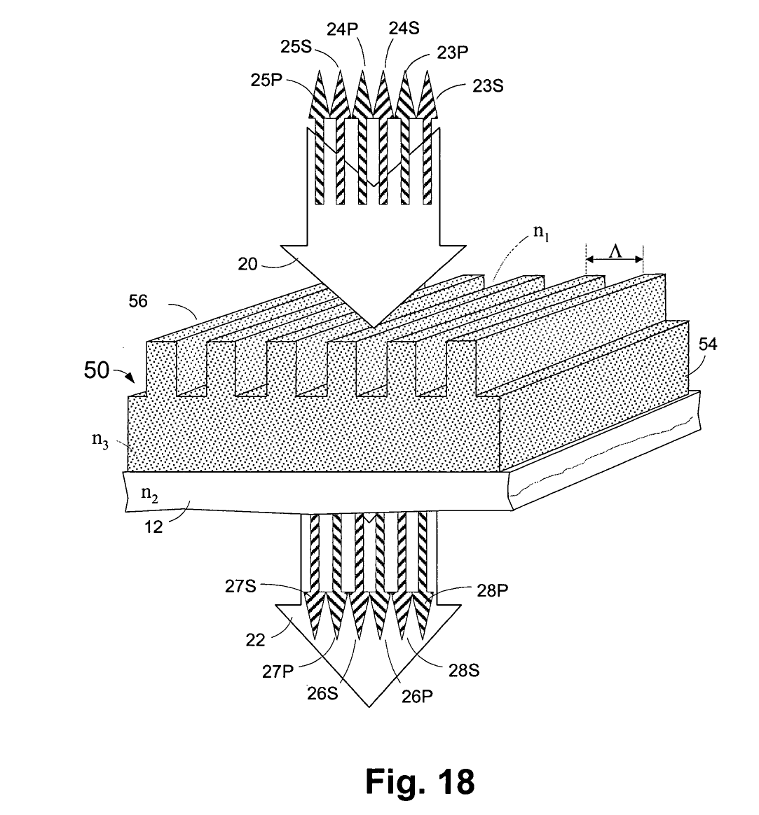

By increasing the thickness of the uniform material layer another quarter of the resonant wavelength, a third polarizing filter band can be produced. FIG. 18 shows polarizing filter device 50 designed with the same materials as device 40, but containing surface relief structures 56 with rectangular profile lines, and with the thickness of layer 54 increased to 240 nm. The width of the grating lines is reduced to just 40% of the grating pitch which is set at 280 nm for this example.

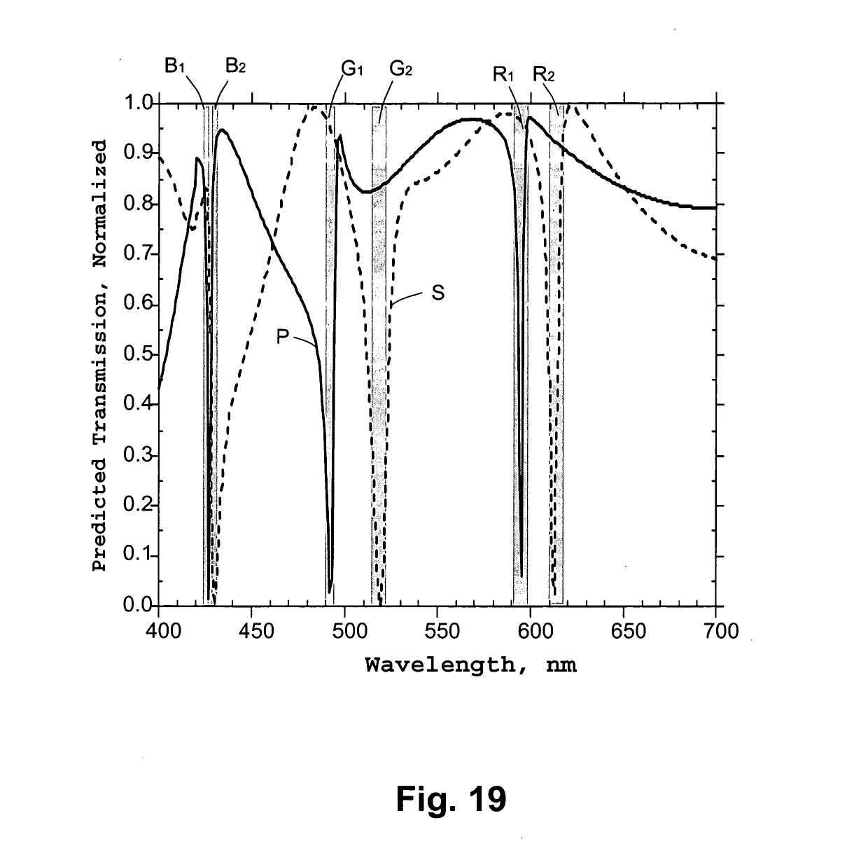

FIG. 19 shows the results of a calculation of the transmission through device 50. The solid curve in FIG. 19 shows that P polarized light with will be reflected out of a broad-spectrum light beam 20 at three wavelengths centered at 595 nm, 490 nm and 425 nm, as represented by 23P, 24P, and 25P of FIG. 10 respectively. Only S polarized light, as represented by 28S, 26S, and 27S of FIG. 18 is transmitted at wavelengths 595 nm, 490 nm and 425 nm. The dashed curve in FIG. 19 shows that S polarized light with will be reflected out of a broad-spectrum light beam 20 at three wavelengths centered at 610 nm, 520 nm, and 430 nm, as represented by 23S, 24S, and 25S of FIG. 18 respectively. Only P polarized light, as represented by 26P and 27P of FIG. 18 is transmitted at wavelengths 610 nm, 520 nm, and 430 nm. The polarizing filter bands centered at wavelengths of 610 nm, 595 nm, 520 nm, 495 nm, 440 nm, and 430 nm are highlighted by the shaded regions in FIG. 19 and are designated as R2, R1, G2, G1, B2, and B1 in the figure.

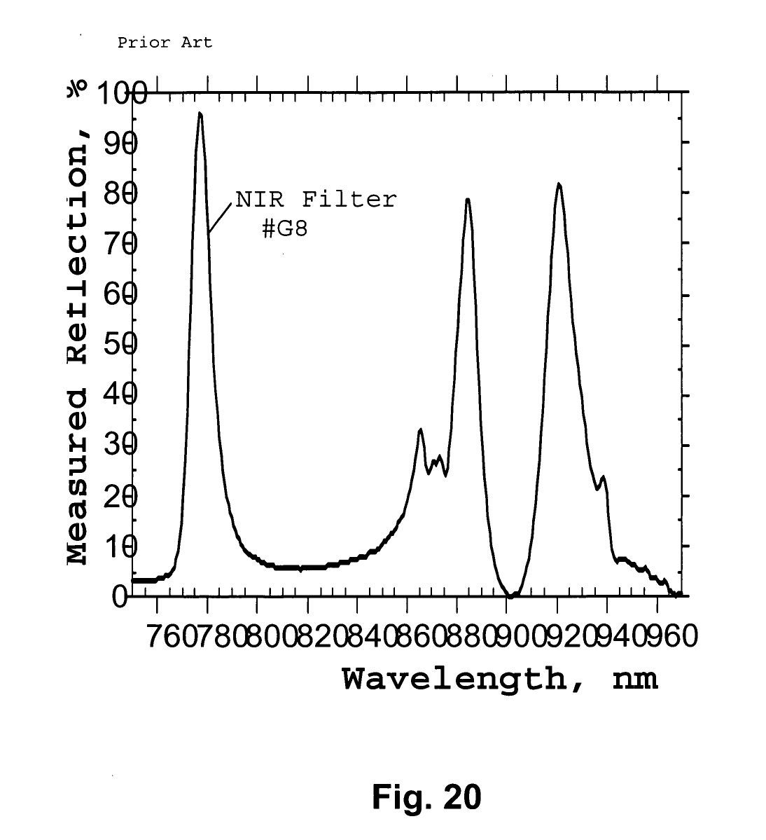

Measured reflectance data from a triple notch, non-polarizing waveguide resonant filter designed for operation on near infrared light, is shown in FIG. 20. The filter was fabricated using a layer of ZnS deposited on a glass substrate. A circularly symmetric array of mesa structures (a honeycomb pattern) was fabricated in the ZnS layer with a thickness of about one half the resonant wavelength. The data shows that waveguide resonant filters can be designed and fabricated to match the spectral emission of most light sources with simple structures that are thin compared to multiple-layer thin film filters with equivalent performance.

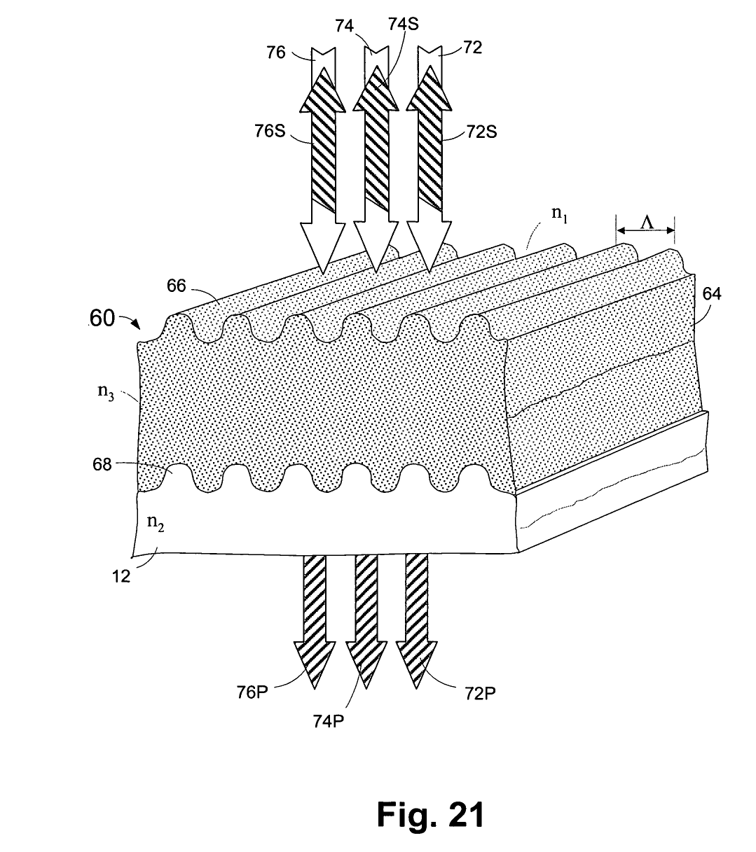

FIG. 21 shows polarizing optical filter device 60 designed to polarize the discrete emission bands from a CCFL backlight. Three un-polarized wavelength bands 72, 74, 76, illuminate device 60 at normal incidence. In this embodiment, a surface relief structure 68 composed of grating lines with a sinusoidal profile and line spacing Λ, are fabricated into the surface of the substrate 12. This can be accomplished by embossing the structure into a plastic substrate, or by replicating the structures in a polymer layer coated onto a substrate, both techniques performed using low-cost, high volume roll-to-roll replication processes similar to that shown in FIG. 15. The surface structure 68 in substrate 12 is then over-coated with material layer 64 that replicates the surface structure 68 as surface structure 66 at the top surface of layer 64. Again the refractive indices of the materials is set such that n1<n3>n2, with n1=1 for air, n3=2.4 for ZnS, and n2=1.48 for glass. The depth and pitch of the grating structures 66, 68, and the thickness of the uniform layer 64 are adjusted to produce three resonant bands matching the CCFL emission lines. The pattern pitch modeled is 230 nm, the grating depth is 80 nm, and the thickness of layer 64 is 335 nm.

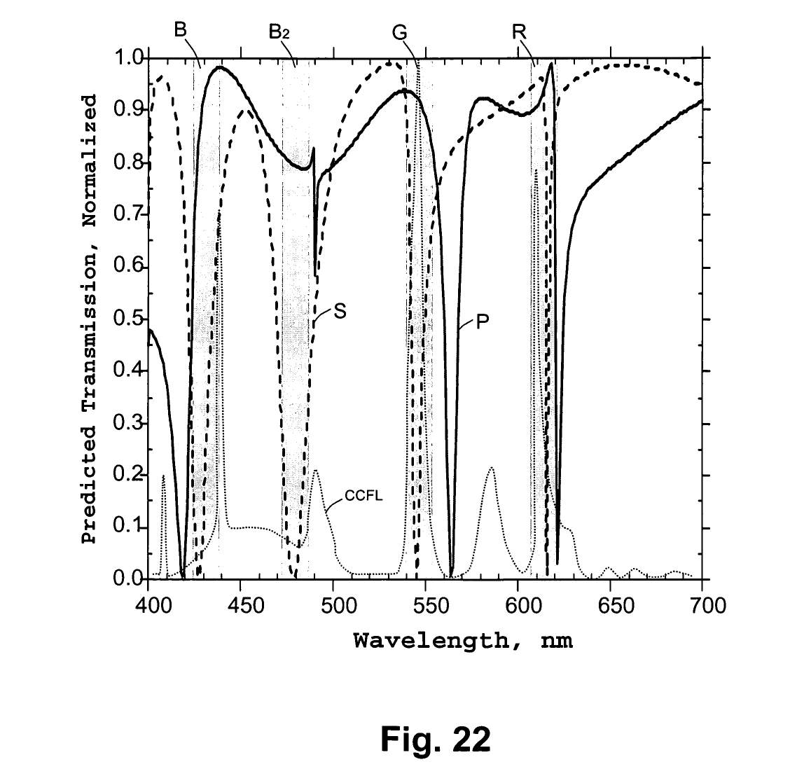

FIG. 22 shows the predicted transmission of polarizing filter 60 when illuminated with both S (dashed curve) and P (solid curve) polarized light in the visible spectrum. Four polarizing bands are predicted centered at wavelengths of 615 nm, 545 nm, 480 nm, and 430 nm, and highlighted by the superimposed grey bands labeled R, G, B2, and B. Within these bands S polarized light is reflected back toward the light source as indicated by 72S, 74S, and 76S in FIG. 21. Only P polarized light is transmitted at these wavelengths as indicated by 72P, 74P, and 76P in FIG. 21. The spectral emission from a CCFL light source is also superimposed in the figure. Note that only the spectral line at 540 nm is properly polarized by device 60. By adjusting the grating 66, 68 pitch, line width, and depth, along with the thickness of layer 64, the CCFL spectral lines at 435 nm and 610 nm can be efficiently polarized.

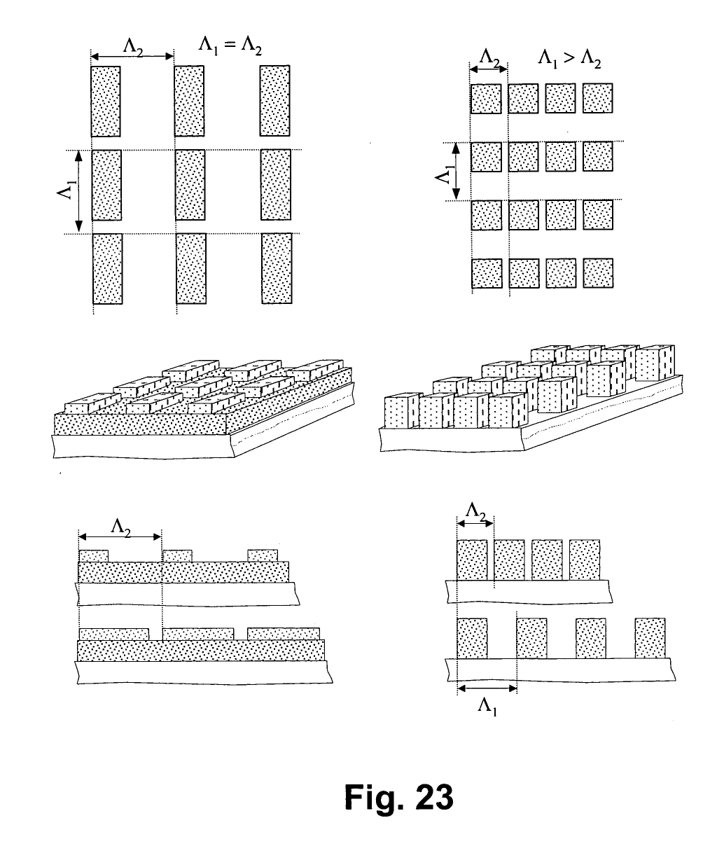

FIG. 23 shows overhead, elevation, and cross sectional diagrams of alternative embodiment polarizing filter structures. Two types of structures are shown where the array of line structures found with previous embodiments is replaced by two dimensional arrays of rectangular or square structures. In the left half of the figure an array of rectangles is shown where the spacing of the rectangles in the array is equal in both directions. The asymmetry of the rectangular structures that is required to achieve the polarizing effect, can be seen as a significant difference in the line to space ratio, or duty cycle shown in the cross sectional views. Light polarized in direction 1 encounters a different resonant condition and will reflect at a different wavelength than light polarized in the orthogonal direction. Such an array of rectangles can be fabricated using conventional two-beam interference lithography techniques where two grating pattern exposures are made with the photoresist layer rotated 90 degrees between exposures and the exposure energy varied to produce wider features in one exposure.

The right half of FIG. 23 shows still another embodiment of a two-dimensional polarizing filter array. In this case the uniform and structural layers are combined in a single waveguide structure. The required asymmetry is produced using symmetric features by varying the pitch of the structures in orthogonal directions. This also presents a different resonant condition for light polarized in one direction than for light polarized in the orthogonal direction. Two dimensional arrays offer the benefit of an additional parameter to vary the pattern symmetry which can allow increased control over the filter band positions.

Many other types of asymmetric structures are suitable for producing polarizing filters. Structures such as cones or holes with vertical or tapered sidewalls and elliptical bases may be used. An array of elliptical holes on a square grid is readily produced using three-beam interference lithography in a right-triangle arrangement.

One aspect of the previous embodiments is that when illuminated by light with a broad spectral content, the polarized band is isolated in the reflected beam. In transmission, the polarized band is superimposed on the un-polarized broad-band beam. Such devices are known in the art as rejection filters. In some color filter array applications, it is desirable to polarize and isolate a wavelength band in a transmitted beam and reflect all other wavelengths. These devices are known in the art as transmission filters. In general, transmission filters have a greater tolerance for light incident at large angles, and in the case of an LCD, unfiltered and un-polarized light can be recycled in the backlight collimating (130, 140 in FIG. 11) and distribution films when reflected by the polarizing filter. This recycling allows more light to be passed through the LCD, yielding a brighter display.

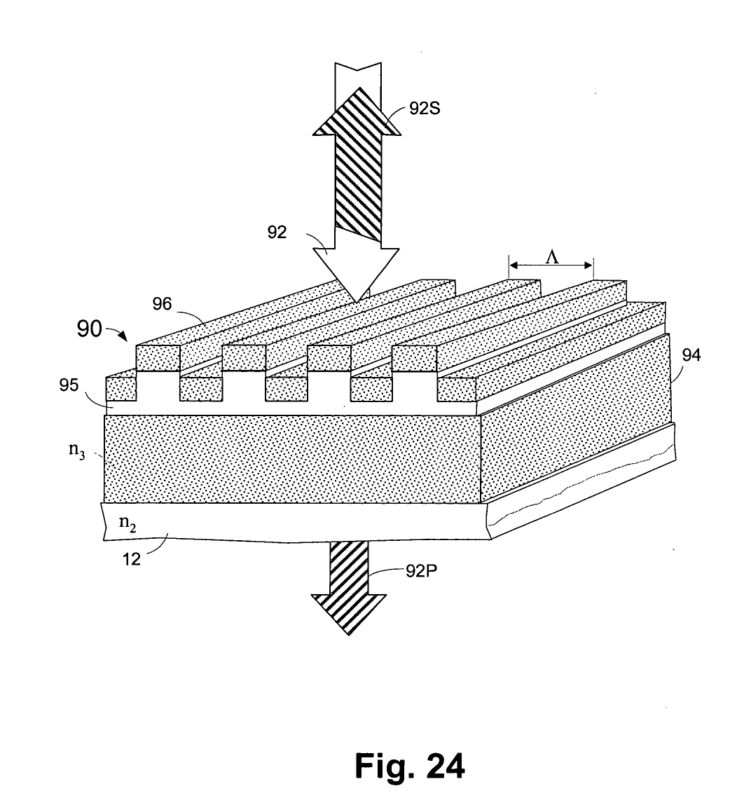

Polarizing surface structure transmission filters can be designed to recycle un-polarized light. FIG. 24 shows a polarizing optical transmission filter 90 designed to simultaneously polarize the blue and green light emitted from a CCFL backlight. As with previous embodiments, the device is composed of surface structures in material layers built upon a substrate 12, where the materials follow the relationship n1<n3>n2. In device 90, a uniform layer 94 is deposited onto substrate 12 and a structural layer 95 composed of an array of rectangular profile lines is built on top of material layer 94 in a material with a refractive index similar to n2. Structural layer 95 is then over-coated by another material layer with refractive index of n3 such that the surface structures 95 are replicated as surface structures 96. In this configuration, a structural waveguide layer is located between highly reflecting layers, one structured 96 and one uniform 94, creating a Fabry-Perot cavity. Only light that resonates within the cavity formed by the structural and uniform waveguide layers 94, 95 will be transmitted. With asymmetric structures forming the waveguide, only S-polarized light within a narrow range of wavelengths will satisfy the resonance condition and be transmitted. S-polarized light with a wavelength that is not resonant within the cavity will be reflected into beam 92S indicated in the figure. With P-polarized light a resonant cavity is not created and broad-band P-Polarized light is transmitted as beam 92P. For P-polarized light within a narrow-range of wavelengths, a resonance within the uniform waveguide 94 is created, and these wavelengths are reflected back superimposed with S-polarized reflected beam 92S.

With the FIG. 24 design, the light that is not resonant with either the microstructures or the resonant cavity setup by the microstructure configuration, is polarized over a broad range of wavelengths. Therefore in contrast with all previous embodiments that produce polarizing color filters with resonant bands that match the spectral content of a particular illumination source, the FIG. 24 design calls for locating the resonant bands at light wavelengths that are not emitted by the source. As a consequence to create a broad-band reflective polarizer based on microstructures, it becomes desirable to minimize the bandwidth of the light that resonates with the microstructures, and to even introduce waveguide defects that effectively suppress or minimize the resonances leaving only the broad-band polarizing function. With minimized coherence between microstructured waveguide layers, the three dimensional structure can be envisioned as a bulk material with an average refractive index that varies with all three axes. The nature of microstructured waveguides produces a large index variation that allows a very small number of layers to perform an equivalent function to devices built with a large number of layers and a small index variation.

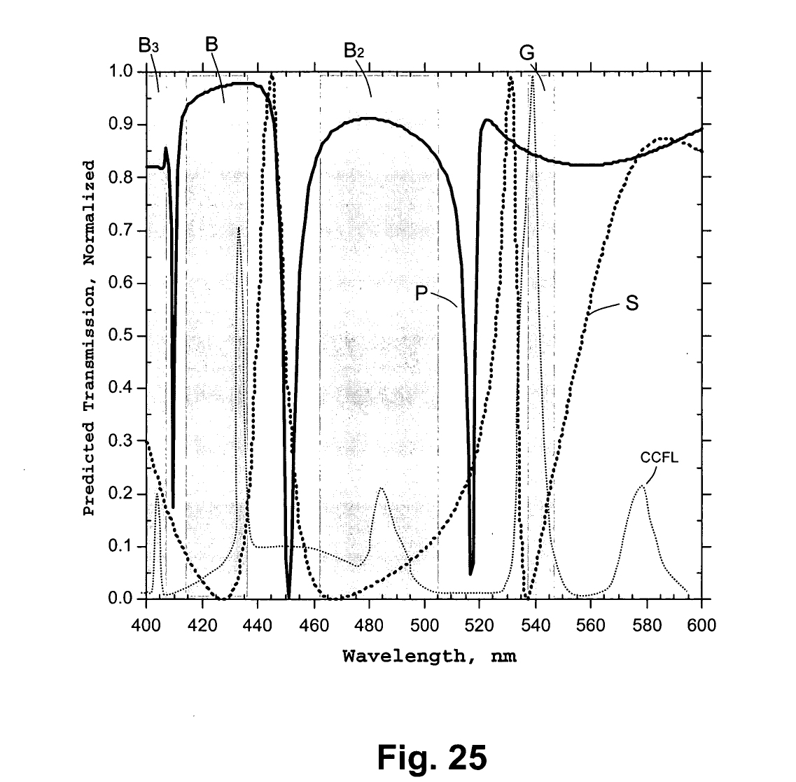

FIG. 25 shows the predicted transmission through device 90 for S (dashed line) and P (solid line) polarized light striking the device at normal incidence. The simulation set the substrate 12 refractive index n2 equal to 1.5 for glass, the uniform waveguide layer 94 index to 2.4 for ZnS and a thickness of 280 nm. The structural layer 95 refractive index n3 was also set to 1.5 with a total thickness of 110 nm, 80 nm of which is modulated by a rectangular cross section grating. ZnS was also set as the refractive index of the overcoat material 96, with a thickness of 80 nm, and air was set as the medium in which the light propagates before striking the device. The spacing, Λ, of the grating was set at 275 nm, and the grating duty cycle was set at 50%. Broad-band white light 92 containing wavelengths ranging from 400 nm to 800 nm, strikes the device at normal incidence.

As discussed above, the nature of the transmitted light predicted by the model is significantly different for S and P polarized light. For S polarized light, two narrow wavelength bands are transmitted, but with P polarized light the predicted transmission is high over broad band with only a few narrow wavelength bands being reflected. This embodiment shows efficient polarization bands located outside the resonant bands that span a much wider wavelength range than previous embodiments. As with previous figures, the polarizing bands are highlighted by grey bars labeled G, B2, B, and B3. The CCFL spectrum is again superimposed in FIG. 25. Notice that four of the six CCFL emission lines are polarized efficiently by device 90.

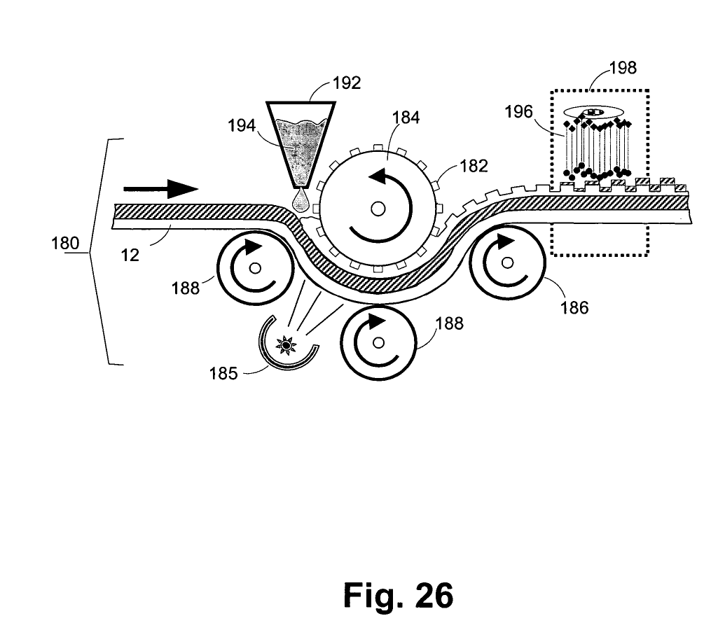

FIG. 26 shows a schematic diagram 180 illustrating a common high volume manufacturing method that can be employed to produce the FIG. 24 inventive device on a roll of flexible plastic sheet film 12. Plastic sheet film 12 is a PET, polycarbonate or other material that meets the FIG. 24 design criteria, coated with a uniform layer of a higher index material such as ZnS. ZnS coated plastic sheet film can be purchased from a variety of sources due to its use in security holograms and identification cards. The coated plastic sheet film is fed through system 180 by a series of cylindrical rollers 186, 188, and 184. Roller 184 contains a series of protruding lines 182 around its perimeter that are shaped and positioned so that as the roller turns a repeating array of relief structures can be produced in the surface of a layer of plastic. The plastic layer is initially dispensed from a hopper 192 as a liquid 194 between the roller 184 and the plastic sheet, and is subsequently converted to a solid by exposure to ultraviolet light 185 (or alternatively by exposure to heat or to an electron-beam). The peel roller 186 serves to release the hardened plastic from the drum roller 184. The microstructured sheet film is then introduced into a coating chamber 198 where another layer of high index material 196 such as ZnS is deposited in a conformal manner on the peaks and filing the valleys between the surface relief grating lines.

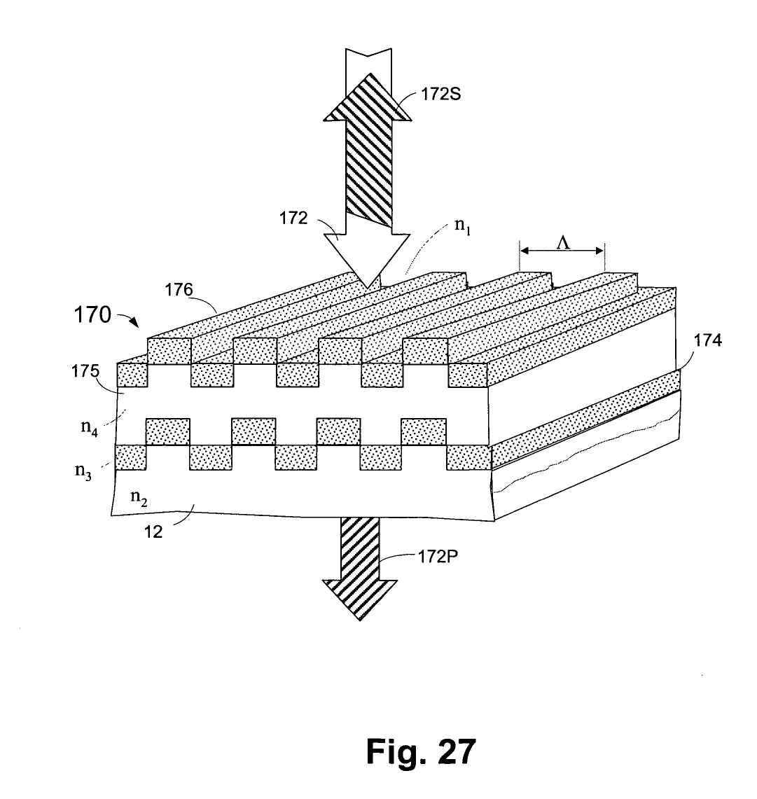

FIG. 27 depicts a polarizing microstructured filter 170 designed for broad-band operation and a reduced number of resonant bands. The model consists of substrate 12 with refractive index n2=1.62 to simulate PET film, a microstructured grating composed of a high index material (n3=2.4 to simulate ZnS) and embedded in the surface of the PET film substrate, this microstructure having a grating period Λ, of 320 nm, a grating duty cycle of 60%, and a modulation depth of 85 nm. A layer of lower index material 175 set to n4=1.5 to simulate a hardened polymer or epoxy, is coated on top of structure 174 in a conformal manner to a total thickness of 170 nm such that the grating structure 174 is replicated in the surface of layer 175. A second high index material (again n3=2.4 to simulate ZnS) is deposited to a thickness of 85 nm in a conformal manner to produce grating structure 176 surrounded by external medium n1=1 for air. Broad-band white light 172 containing wavelengths ranging from 400 nm to 800 nm, strikes the device at normal incidence.

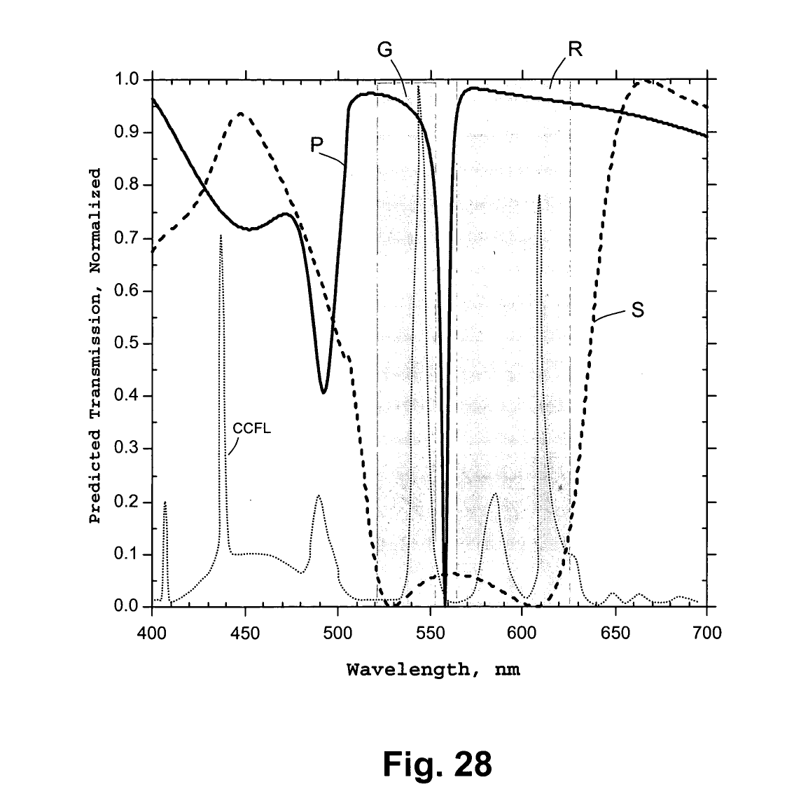

FIG. 28 shows the predicted transmission through device 170 for S (dashed line) and P (solid line) polarized light. Two broad polarizing bands are predicted in the green and red regions of the visible light spectrum, and highlighted by the superimposed grey bands labeled R, and G. Within these bands S polarized light is reflected back toward the light source as indicated by 172S, in FIG. 27. Only P polarized light is transmitted at these wavelengths as indicated by 172P in FIG. 27. The spectral emission from a CCFL light source is also superimposed in the figure. The model indicates that device 170 will efficiently polarize the green and red light emitted by a CCFL source with a polarization contrast that exceeds 90:1 in the green and exceeds 100:1 for the red emission lines. The blue light outside the polarizing bands will be transmitted with an average of about 70% with the remaining 30% reflected back toward the light source. Note that due to the reduced thickness of the structural waveguide layers, the resonant bands for S-polarized light are eliminated, and the resonant bands for P-polarized light are narrowed and suppressed in efficiency.

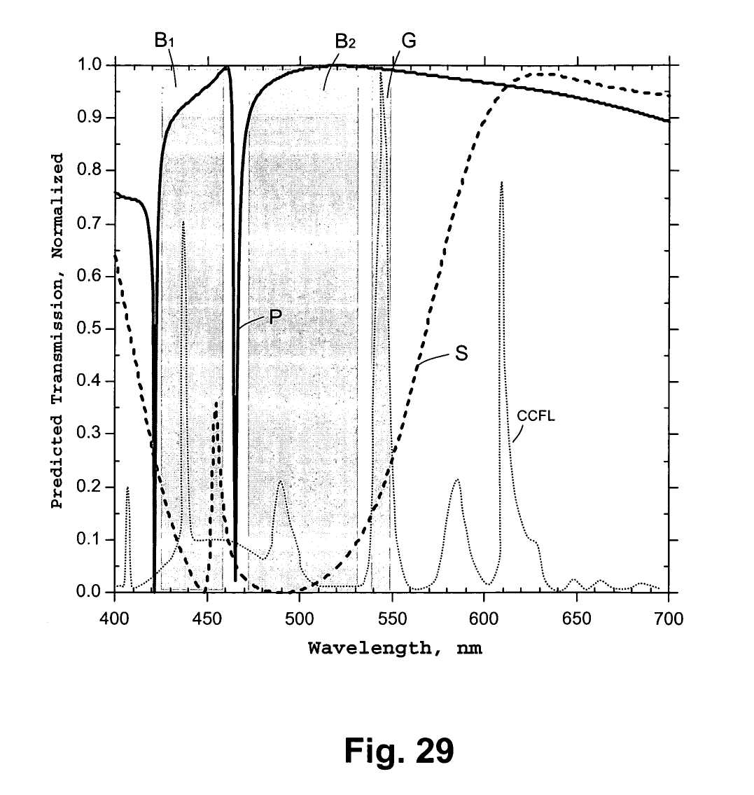

With only a simple change in the grating spacing from a 320 nm to a 260 nm period, the polarizing bands shown in FIG. 28 are predicted to shift into the blue green spectral range as shown in FIG. 29 where as with previous plots, the predicted transmission through device 170 for S and P polarized light is indicated by the dashed and solid lines, respectively. Two broad polarizing bands and one less efficient polarizing band are predicted in the green and blue regions of the visible light spectrum, and highlighted by the superimposed grey bands labeled B1, B2, and G. Within these bands S polarized light is reflected back toward the light source as indicated by 172S, in FIG. 27. Only P polarized light is transmitted at these wavelengths as indicated by 172P in FIG. 27. The spectral emission from a CCFL light source is also superimposed in the figure. The model indicates that device 170 will efficiently polarize most of the blue light emitted by a CCFL source with a polarization contrast that exceeds 90:1.

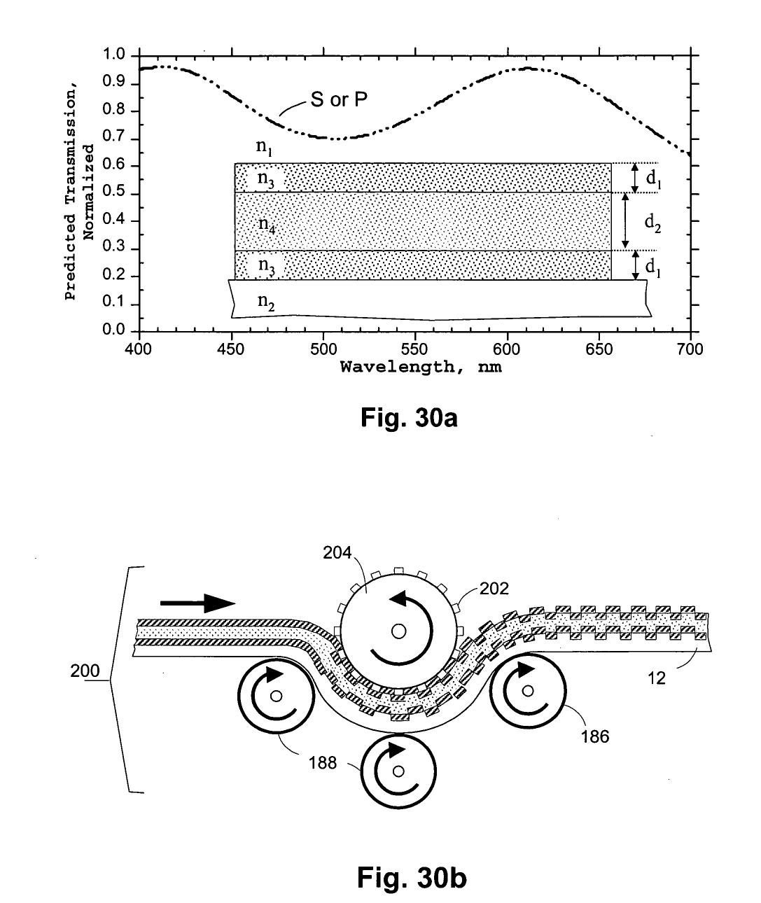

FIGS. 30a and 30b illustrate a means of manufacturing the FIG. 27 reflective polarizing filter design. The process begins with a roll of flexible plastic sheet film (PET, n2=1.62) coated with a three layer stack of thin-films consisting of ZnS (n3=2.4) and SiO2 (n4=1.5) or acrylic (n4=1.48). The thickness of the ZnS layers d1 is set at 85 nm, and the thickness of the acrylic layer d2 is 170 nm. A cross section of the film stack and substrate is shown as an inset to a plot of the normal incidence transmission of visible band light through the coated film sheet. Note that the transmission for both S and P polarized light is identical—indicating no polarizing effect.

FIG. 30b illustrates roll to roll manufacturing system 200 that serves to directly emboss the FIG. 27 grating structure into the coated PET film. The coated PET film is fed through the system by cylindrical rollers 188, 186, and 204. Rollers 188 press the PET coated film against roller 204 with sufficient force to cause the surface protrusions 202 to be stamped into the three film layers such that a repeating series of square cross section grooves are replicated in each film layer and in the surface of the PET film. Peel roller 186 serves to release the embossed film from the master roller 202.

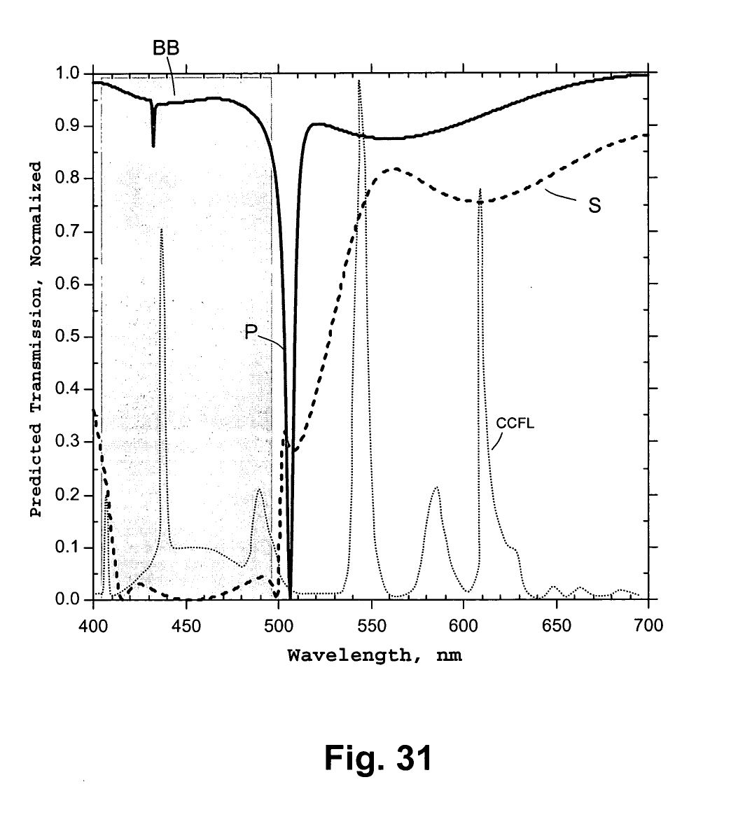

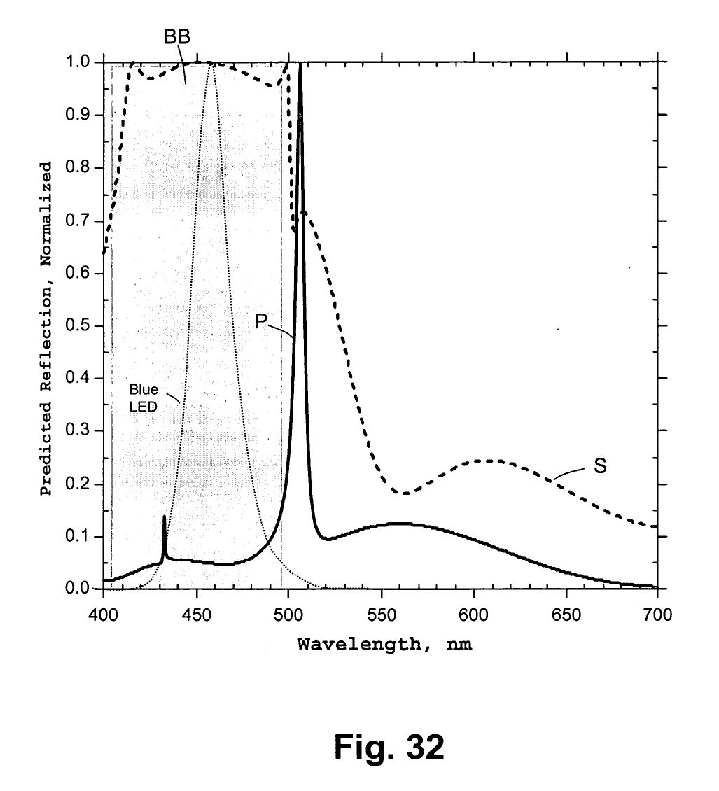

With the FIG. 30b manufacturing process, minor variations from the FIG. 27 design are expected such as sloped groove sidewalls and decreased structure depth for the materials layers adjacent to the PET film. Each of these structure defects will serve to suppress the narrow band resonances produced without reducing the polarizing contrast. FIG. 31 shows the predicted transmission of visible band light through the FIG. 27 structure modified to include sloped sidewall grooves and unequal layer thickness. All other parameters remain the same as with the FIG. 29 model. The efficient polarizing band width in the blue spectral region has increased to nearly 100 nm with strong suppression of one of the resonances for P-polarized light. The polarizing band is indicated by the shaded grey area and labeled as BB. Again the superimposed CCFL emission spectrum shows that efficient polarization of all of the blue-violet light emitted can be attained. To clarify the performance predicted by the FIG. 31 model, FIG. 32 shows a plot of the predicted reflection of visible light from the inventive structure. In this plot the S-Polarized light represented by the dashed line, will be strongly reflected for blue-violet wavelengths whereas P-polarized blue-violet light (solid line) will experience little reflection. Also in this plot the emission spectrum of a common blue LED is superimposed to illustrate that efficient polarization of typical light sources used for LCDs can be attained. FIG. 32 shows curves which are the inverse of the curves shown in FIG. 31, confirming the no loss nature of the inventive device and the potential for recycling light when used in a back-lit LCD application.

The concept of light recycling in an LCD backlight as a result of reflection from the reflective polarizer 136 relies on the rotation of the reflected polarization state from an S to a P state or from a P to S state. It is expected that after multiple reflections from the BEF 133, 134, and diffusing films 144, the polarization state will be converted from a state that is reflected by the reflective polarizer 136, to a state which is transmitted. Some reflected light may only require a few reflections to convert a polarization state from a blocked to a passed state, while other light may take hundreds of reflections, increasing the likelihood that the light is lost to the system apertures and housing. To promote a more rapid conversion of polarization state of reflected light from a reflective polarizer device, a phase retarding element can be employed. In just two passes through a uniaxial crystal quarter-wave phase retarding element oriented with its extraordinary index crystal axis rotated 45 degrees relative to the grating direction of the inventive device, a 90 degree rotation of the light polarization state will occur, converting S polarized light to P polarized light, or P to S. It is another object of the invention to provide an enhanced transmission of polarized light through the disclosed reflective polarizer device through incorporation of a quarter-wave phase retarding element located between the reflective polarizer and the illumination source of a back lit LCD. This object can be accomplished using standard stretched thin film quarter-wave plastic sheets, or by the embossing of a sub-wavelength period, high aspect ratio grating into the surface of a suitable plastic film such as PET. Inventive device 170 could incorporate such an embossed quarter-wave retarding structure on the back side of the PET substrate used in the preferred embodiment.

Referring again to FIGS. 28, 29 and 31, note that the transmission outside the polarizing bands is high suggesting that the function of the FIG. 28 device can be combined in series with the FIG. 29 or 30 device to produce a broad-band reflective polarizer device that efficiently polarizers the entire visible light spectrum. One way that the FIG. 28 device can be combined with the FIG. 29 or 30 device is to emboss a PET film coated on both sides with the FIG. 30a film stack and then to separately or simultaneously emboss the FIG. 28 device on one side of the film and the FIG. 29 or 30 device on the opposite side of the film.

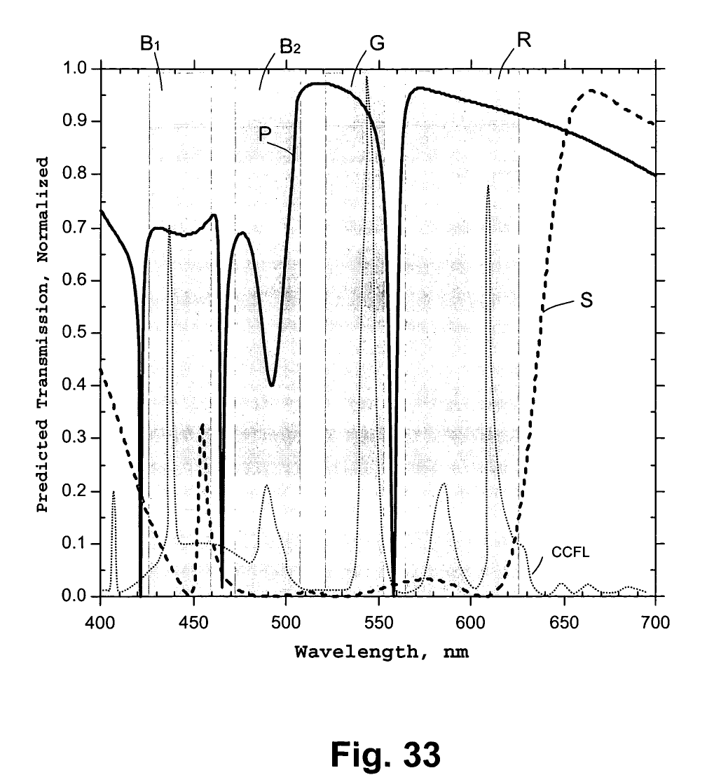

FIG. 33 shows the predicted transmission of visible light through a PET film supporting structures as shown in FIG. 27 on both sides of the film. The FIG. 28 and FIG. 29 models were simulated to produce the FIG. 33 result. The transmission of P-polarized light is represented by the solid line, and the transmission of S-polarized light is represented by the dashed line. Again the spectrum of the CCFL light source is included in the figure. The figure shows that the entire spectrum of light emitted by the CCFL source will be polarized by the inventive device and that highly efficient polarization will be produced for the strong red, green and blue emission lines. These efficient polarizing bands are indicated by the grey areas in the figure and are labeled B1, B2, G, and R. Note that the reduced transmission in the blue region of the spectrum does not indicate a light loss. Light not transmitted in this region will be reflected back into the LCD light source where as discussed above it can be recycled.

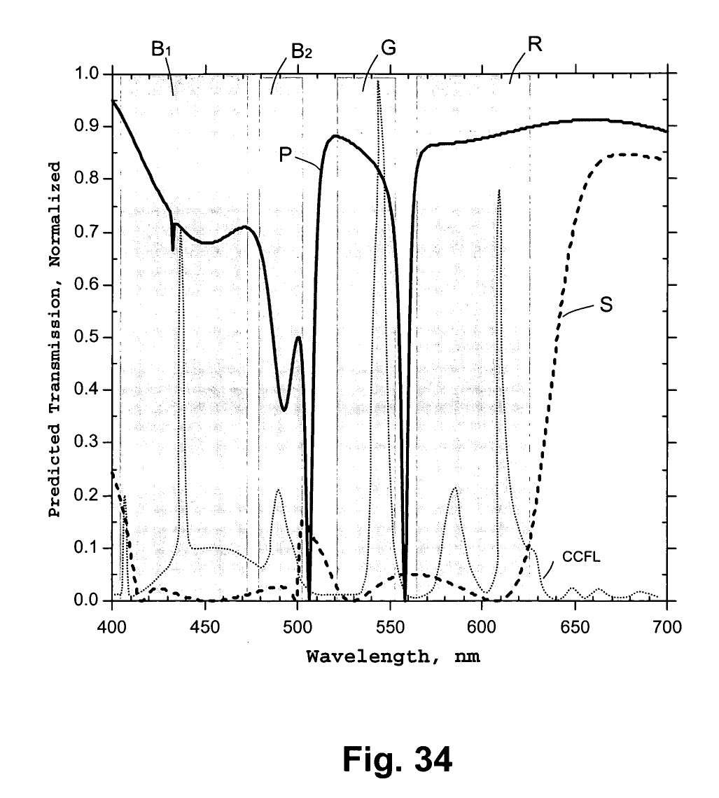

FIG. 34 also shows the predicted transmission of visible light through a PET film supporting structures as shown in FIG. 27 on both sides of the film. To show the effect of suppressing resonances with the combination structure, the FIG. 30 model is combined with the FIG. 28 model to produce the FIG. 34 result. The transmission of P-polarized light is represented by the solid line, and the transmission of S-polarized light is represented by the dashed line. Again the spectrum of the CCFL light source is included in the figure. The figure shows that the entire spectrum of light emitted by the CCFL source will be polarized by the inventive device and that highly efficient polarization will be produced for the strong red, green and blue emission lines. These efficient polarizing bands are indicated by the grey areas in the figure and are labeled B1, B2, G, and R. With this design the width of the resonant notches in the P-polarized light transmission have been reduced and suppressed in the blue region. Also the transmission of S-polarized light has been reduced significantly over a 200 nm bandwidth with only minor peaks due to resonant light. In particular the average polarization contrast for visible light exceeds 80:1.

What is claimed is:

1. An apparatus for filtering and polarizing electromagnetic waves, the apparatus comprising:
a first substrate having a surface relief structure containing at least one dielectric body with physical dimensions smaller than the wavelength of the filtered electromagnetic waves, such structures repeated in a one or two dimensional array covering at least a portion of the surface of the first substrate, and
said surface relief structures of the substrate being composed of or immersed in a material sufficient to form a guided mode resonance filter, and
said dielectric bodies configured with unequal dimensions as observed in a plane parallel to the plane containing the substrate, or where the repeat period of said dielectric bodies in one direction of the two dimensional array is not equal to the repeat period in the orthogonal direction.

2. An apparatus as in claim 1, wherein the dimensions of the surface relief structures are adjusted to filter and polarize more than one wavelength range of electromagnetic waves.

3. An apparatus as in claim 2, wherein the wavelength ranges of filtered electromagnetic waves corresponds with the wavelength distribution of a cold cathode fluorescent lamp.

4. An apparatus as in claim 2, wherein the wavelength ranges of filtered electromagnetic waves correspond with the wavelength distribution of an LED light source.

5. An apparatus as in claim 1, wherein the individual dielectric bodies in the surface texture are lines repeated in an array over the substrate surface.

6. An apparatus as in claim 5, wherein the individual dielectric bodies have conical, elliptical, square, rectangular, sinusoidal, hexagonal, or octagonal cross sectional profiles.

7. An apparatus as in claim 1, wherein the individual dielectric bodies in the surface texture are rectangular or elliptical posts or holes repeated in an array over the substrate surface.

8. An apparatus as in claim 7, wherein the individual dielectric bodies have conical, elliptical, square, rectangular, sinusoidal, hexagonal, or octagonal cross sectional profiles.

9. An apparatus as in claim 1 further comprising;
one or more substrates containing surface relief structures as in claim 1, the surface relief structures on each substrate configured to filter and polarize different wavelength regions from the illuminating electromagnetic waves, and
said substrates superimposed such that the illuminating electromagnetic waves are filtered by each substrate in series.

10. An apparatus as in claim 1 further comprising;
localized regions on each substrate containing surface relief structures as in claim 1, the surface relief structures within each localized region configured to filter and polarize different wavelength regions from the illuminating electromagnetic waves, and
said localized regions repeated in an array covering the substrate such that different regions of the illuminating electromagnetic waves are filtered by different localized regions simultaneously in parallel.

11. An LCD display, comprising:
a light source;
a reflective polarizer that selectively transmits light from the light source with one polarization state and reflects light with the orthogonal polarization state; and
a liquid crystal module that receives the light transmitted by the reflecting polarizer, the liquid crystal module comprising a polarizing array comprising the apparatus of claim 1.

12. A laser cavity mirror comprising the apparatus of claim 1.

13. An optical encoding device, comprising:
a light source; and
an apparatus of claim 1 that receives the light from the source and reflects light at at least one wavelength and having one polarization state, and transmits light at least one other wavelength and having the orthogonal polarization state.

14. A polarizing color filter, comprising:
an array of separate pixels, each pixel comprising a plurality of discrete color filter windows that each transmit a different narrow portion of the visible light spectrum, each window comprising an apparatus of claim 1.

15. A polarizing filter comprising the apparatus of claim 1 having a waveguide defined by a uniform layer of a material with a first index of refraction, and the surface relief structure made of a material having a second index of refraction, in which the first index of refraction is substantially greater than the second index of refraction.
